(19) United States
(12) Patent Application Publication
(10) Pub. No.: US 2025/0064062 A1
(43) Pub. Date: Feb. 27, 2025

(54) METHOD FOR INCREASING THE EFFICACY OF A HERBICIDE

(71) Applicant: BASF SE, Ludwigshafen (DE)

(72) Inventors: Dean A. Oester, Cincinnati, OH (US); Timothy H. Anderson, Cincinnati, OH (US); Steven Joseph Bowe, Research Triangle Park, NC (US)

(21) Appl. No.: 18/709,059

(22) PCT Filed: Nov. 14, 2022
(86) PCT No.: PCT/EP2022/081770

§ 371 Date: May 10, 2024

(30) Foreign Application Priority Data
Nov. 15, 2021 (EP) 21208262.2

(51) Int. Cl. A01N 57/20; A01N 25/06; A01N 25/10; A01N 37/10

(52) U.S. Cl. CPC A01N 57/20; A01N 25/06; A01N 25/10; A01N 37/10

(57) ABSTRACT

A method for increasing the efficacy of a herbicide which comprises applying an aqueous spray liquor of the herbicide in combination with an anionic copolymer CP, where the copolymer CP is made of repeating units of polymerized ethylenically unsaturated monomers M comprising a) 50 to 99.5% by weight, based on the total weight of ethylenically unsaturated monomers M, of at least one monomer Ma selected from the group consisting of primary amides of a monoethylenically unsaturated monocarboxylic acid having 3 to 6 carbon atoms; b) 0 to 50% by weight, based on the total weight of ethylenically unsaturated monomers M, of one or more monomers Mb, where the monomer Mb is either—at least one monomer Mb. 1 selected from the group consisting of monoethylenically unsaturated sulfonic acids and the salts thereof; or—at least one monomer Mb.2 selected from the group consisting of monoethylenically unsaturated monomers bearing at least one quaternary ammonium group; and c) 0 to 15% by weight, based on the total weight of ethylenically unsaturated monomers M, of one or more monoethylenically unsaturated monomers Me having at least one poly-C₂-C₆-alkyleneoxide moiety which has a terminal OH group or a terminal C₁-C₆-alkxoy group in addition to the moiety bearing an ethylenically unsaturated double bond; where the total amount of monomers Ma and Mb is at least 85% by weight, based on the total weight of ethylenically unsaturated monomers M, and where the total amount monomers Mb and Mc is from 0.5 to 50% by weight, based on the total weight of ethylenically unsaturated monomers M.

The present invention relates to a method for increasing the efficacy of a herbicide which comprises applying an aqueous spray liquor of the herbicide in combination with a copolymer CP. The invention also relates to the use of use of the copolymer CP as defined herein for increasing the biological activity, hereinafter efficacy, of herbicides.

In agriculture, herbicides are widely applied in order to control growth of undesirable plants, such as weeds, because the undesired plants compete with crop plants for water, nutrition and sunlight and therefore reduce crop yields and crop quality. Herbicides may be applied to clear cropland of undesirable plants before sowing or planting crop plants. However, depending on the crops and their compatibility with the herbicide, the herbicide may also be applied to fields where the crop plants grow.

In order to be effective, herbicides must overcome a variety of barriers (morphological, biological, and environmental) to their entry into target plants. For example, trichomes on the leaf surface can reduce herbicide efficacy by intercepting spray droplets before they contact the epidermal surface. Environmental stress (e.g., hot, dry weather) may develop a thicker than normal wax layer, or increase other defensive structures such as reducing the plant's metabolic and transport processes that are required for adequate weed control. Consequently, the biological activity of a herbicide may not be satisfactory or at least lower than expected. While higher application rates may achieve better herbicidal efficacy, this is often not possible for regulatory reasons and is not desirable for ecological and economic reasons. Rather, there is great interest in increasing the biological effectiveness, also termed efficacy or biological efficacy, of herbicides in order to reduce application rates and/or improve weed control in this way.

It is well known that the efficacy of herbicides can be increased by certain adjuvants. Adjuvants (from Latin, adiuvare:to aid) are commonly used in agriculture to improve the performance of herbicides or other pesticides, including better mixing and handling, increased effectiveness and safety, better distribution, and drift reduction. Broadly defined, an adjuvant is an ingredient that aids or modifies the action of the principal active ingredient. Adjuvants can be roughly classified into 3 groups:
(1) Activators
(2) Spray modifiers and
(3) Utility modifiers Activators will mainly increase the efficacy of the herbicides by various modes of action.

Activators are typically surfactants, in particular non-ionic surfactants (NIS), including silicone surfactants, oils, such as high surfactant oils, crop oil concentrates, vegetable oil concentrates and modified vegetable oil concentrates, and wetting agents. Spray modifiers will alter the properties of the aqueous spray liquor and thus facilitate aiming the herbicide spray, reduce herbicide drift in the air or may cause the spray to more readily adhere to the plant by various mechanisms. Utility modifiers help minimize handling and application problems. They widen the conditions when a herbicide can be used or maintain the integrity of the spray solution. For example, utility modifiers reduce foaming, increase solubility, modify pH, or reduce spray drift. In contrast to activators, spray modifiers and utility modifiers usually do not improve the biological efficacy of the pesticide but facilitate the application of the aqueous pesticide spray liquor.

A review about adjuvant technology is given by Z. Pacanosky, Herbicide Adjuvants (2015), DOI: 10.5772/60842. A summary of commercially available adjuvants for herbicides, hereinafter herbicide adjuvants, is given by B. G. Young et al. (ed.) “Compendium of Herbicide Adjuvants”, 13^{th} Edition (2016), Purdue Extension and Southern IIIinois University (https://mdc.itap.purdue.edu/item.asp?ltem_Number=PPP-115).

U.S. Pat. No. 6,372,842 describes copolymers of hydrophobic monomers selected from N-alkyl acrylamides or alkyl acrylates and hydrophilic monomers selected from acrylamidoalkyl sulfonic acid, acrylamidoalkyl disulfonic acids and styrene sulfonic acids. The copolymers are suitable for controlling the undesired formation of very small droplets (mist or aerosol) when aqueous compositions are subjected to shear stress, e.g. when spraying an aqueous pesticide spray liquor.

U.S. Pat. No. 6,288,010 describes aqueous compositions containing a water-soluble inorganic compound, in particular an ammonium fertilizer, and 1.9 g/L of an anti-drift agent which is selected from water-soluble anionic polymers, such as copolymers of acrylamide and acrylic acid. These aqueous compositions are used as additives for aqueous spray liquors of pesticides such that the amount of the copolymer in the spray liquor is at least 500 ppm.

US 2019/110467 describes the use of high molecular weight copolymers of acrylamide and at least one polyether macromonomer and optionally an acidic monomer selected from 2-acrylamid-2methylpropane sulfonic acid and acrylic acid for improving spray drift performance of aqueous pesticide spray liquors. The polymers serve for reducing the amount of droplets having a droplet size of below 100 μm when applying the aqueous spray liquor. The copolymers are not mentioned to increase the activity of herbicides.

While the above mentioned activators, namely surfactants, oils and wetting agents, may be suitable for increasing the biological activity of herbicide active compounds, they must be applied at comparatively high application rates which may not be desirable for economic or ecological reasons. There is an ongoing need to find substances which increase the biological activity of herbicides at low application rates.

It was surprisingly found that the copolymers CP as defined herein increase the herbicidal activity of herbicide compounds when applying an aqueous spray liquor of the herbicide compound.

The copolymer CP are made of repeating units of polymerized ethylenically unsaturated monomers M comprising
a) 50 to 99.5% by weight, in particular 65 to 99% by weight or 70 to 99% by weight, especially 75 to 98% by weight or 80 to 98% by weight, based on the total weight of ethylenically unsaturated monomers M, of at least one monomer Ma selected from the group consisting of primary amides of a monoethylenically unsaturated monocarboxylic acid having 3 to 6 carbon atoms atoms;
b) 0 to 50% by weight, e.g. 0.5 to 50% by weight or 0.5 to 35% by weight or 0.5 to 30% by weight or 0.5 to 25% by weight or 0.5 to 20% by weight or 0.5 to 15% by weight, in particular 1 to 50% by weight or 1 to 35% by weight or 1 to 30% by weight or 1 to 25% by weight or 1 to 20% by weight or 1 to 15% by weight, more particularly 1.5 to 30% by weight or 1.5 to 25% by weight or 1.5 to 20% by weight or 1.5 to 15% by weight, and especially 2.0 to 25% by weight or 2 to 20% by weight or 2.0 to 15% by weight, based on the total weight of ethylenically unsaturated monomers M, of one or more monomers Mb, where the monomer Mb is either
   at least one monomer Mb.1 selected from the group consisting monoethylenically unsaturated sulfonic acids and the salts thereof; or
   at least one monomer Mb.2 selected from the group consisting monoethylenically unsaturated monomers bearing at least one quaternary ammonium group;
c) 0 to 15% by weight or 0.1 to 15% by weight, in particular 0 to 8% by weight or 0.2 to 8% by weight, especially 0 to 5% by weight or 0.5 to 5% by weight, based on the total weight of ethylenically unsaturated monomers M, of one or more monoethylenically unsaturated monomers Mc having at least one poly-C₂-C₆-alkyleneoxide moiety which has a terminal OH group or a terminal C₁-C₆-alkxoy group in addition to the moiety bearing an ethylenically unsaturated double bond;
where the total amount of monomers Ma and Mb is at least 85% by weight, in particular at least 92% by weight, and especially at least 95% by weight, based on the total weight of ethylenically unsaturated monomers M, and where the total amount monomers Mb and Mc is from 0.5 to 50% by weight, in particular from 1 to 35% by weight or 1 to 30% by weight, or 1 to 25% by weight or 1 to 20% by weight, preferably from 1.5 to 25% by weight or 1.5 to 20% by weight or 1.5 to 15% by weight, especially 2 to 25% by weight or 2 to 20% by weight or 2 to 15% by weight, based on the total weight of ethylenically unsaturated monomers M.

Therefore, the present invention relates to a method for increasing the efficacy of a herbicide which comprises applying an aqueous spray liquor of the herbicide in combination with an copolymer CP, where the copolymer CP is as described herein.

The present invention also relates to the use of the copolymer CP as defined herein for increasing the efficacy of a herbicide, in particular, when the herbicide is applied as an aqueous spray liquor containing the herbicide.

The present invention also relates to an aqueous spray liquor containing a herbicide and a copolymer CP as defined herein, where the copolymer CP is made of monomers M that essentially consist of
a) 50 to 99.5% by weight, in particular 65 to 99% by weight or 70 to 99% by weight, especially 75 to 98% by weight or 80 to 98% by weight, based on the total weight of ethylenically unsaturated monomers M, of at least one monomer Ma selected from the group consisting of primary amides of a monoethylenically unsaturated monocarboxylic acid having 3 to 6 carbon atoms; and
b) 0.5 to 50% by weight or 0.5 to 35% by weight or 0.5 to 30% by weight or 0.5 to 25% by weight or 0.5 to 20% by weight or 0.5 to 15% by weight, in particular 1 to 50% by weight or 1 to 35% by weight or 1 to 30% by weight or 1 to 25% by weight or 1 to 20% by weight or 1 to 15% by weight, more particularly 1.5 to 30% by weight or 1.5 to 25% by weight or 1.5 to 20% by weight or 1.5 to 15% by weight, and especially 2.0 to 25% by weight or 2 to 20% by weight or 2.0 to 15% by weight, based on the total weight of ethylenically unsaturated monomers M, of one or more monomers Mb, where the monomer Mb is either
   at least one monomer Mb.1 selected from the group consisting of monoethylenically unsaturated sulfonic acids and the salts thereof; or
   at least one monomer Mb.2 selected from the group consisting of monoethylenically unsaturated monomers bearing at least one quaternary ammonium group and where the copolymer CP in particular has at least one of the following properties i), ii), iii), iv), v) or vi):
i) the monomer Ma is acrylamide;
ii) the monomers M comprise from 0.5 to 50% by weight, of at least one monomer Mb.1; ii) the monomer Mb.1 is 2-acrylamido-2-methylpropane sulfonic acid or a salt thereof; iv) the monomers M consist of
   a) 70 to 99% by weight, in particular 75 to 99% by weight or 75 to 98.5% by weight or 75 to 98% by weight, preferably 80 to 99% by weight or 80 to 98.5% by weight or 80 to 98% by weight, especially 85 to 99% by weight or 85 to 98.5% by weight or 85 to 98% by weight, based on the total weight of the ethylenically unsaturated monomers M, of acrylamide;
   and
   b) 1 to 30% by weight, in particular 1 to 25% by weight or 1.5 to 25% by weight or 2 to 25% by weight, preferably 1 to 20% by weight or 1.5 to 20% by weight or 2 to 20% by weight, especially 1 to 15% by weight or 1.5 to 15% by weight or 2 to 15% by weight, based on the total weight of the ethylenically unsaturated monomers M, of 2-acrylamido-2-methylpropane sulfonic acid or a salt thereof.
v) the copolymer CP in the form of its sodium salt has a weight average molecular weight Mw of at least 100,000 g/mol, in particular at least 250,000 g/mol, more particular at least 500,000 g/mol, as determined by gel permeation chromatography
vi) the copolymer CP in the form of its sodium salt has an intrinsic viscosity [η] of at least 50 cm³/g, in particular at least 100 cm³/g, preferably at least 150 cm³/g, especially at least 200 cm³/g as determined at 30° C. in 0.5 M aqueous solution of sodium chloride;
vii) the monomers M consist of
   a) 95 to 99.5% by weight, based on the total weight of the ethylenically unsaturated monomers M, of acrylamide;
   and
   b) 0.5 to 5% by weight, based on the total weight of the ethylenically unsaturated monomers M, of a monomer Mb.2, which is in particular a N-(3-trimethylammoniumpropyl) acrylamide salt.

The present invention also relates to an aqueous spray liquor containing a herbicide and a copolymer CP as defined herein in an amount of 10 to 100 ppm, based on the total weight of the spray liquor.

The present invention also relates to an aqueous spray liquor containing a herbicide comprising glufosinate, glyphosate or dicamba or a salt thereof and a copolymer CP as defined herein, where the amount of the copolymer CP is in particular in the range of 5 to 500 ppm or in the range of 10 to 300 ppm, more particularly in the range of 10 to 200 ppm, especially the range of 10 to 100 ppm, based on the total weight of the aqueous spray liquor.

When applying the herbicide in a usual way, the presence of the copolymer CP results in an increased or enhanced herbicidal activity, i.e. in an increased control of the growth of the target plants, compared to the control experiment, i.e. compared to the application of the herbicide in the same way and at the same application rate but in the absence of the copolymer CP. The control of the growth of the target plants is typically given by a scale of 0% of no control to 100% for complete control which is a scale typical for use by an agronomist skilled in the art. A statistically relevant increase of control is achieved, when the control achieved in the presence of the copolymer CP is at least 0.5% higher, in particular at least 1.0% higher compared to the control experiment at 14 days after treatment (14 DAT) or 28 days after application (28 DAT). In the context of the invention, the term “increasing the efficacy” is therefore understood that the herbicidal activity of the herbicide, i.e. the control of the target plant by the target plant, is increased.

Surprisingly, the increased efficacy of the herbicides is achieved at very low concentrations of the copolymer CP in the aqueous spray liquor. In particular, a significant increase in the efficacy is observed at concentrations of the copolymer CP of 5 ppm or higher. Preferably, the concentration of the copolymer CP in the aqueous spray liquor will not exceed 500 ppm, in particular 300 ppm or especially 200 ppm. Preferably, the amount of the copolymer CP in the aqueous spray liquor is in the range of 5 to 500 ppm, in particular in the range of 10 to 300 ppm, more particularly in the range of 10 to 200 ppm, especially the range of 10 to 100 ppm, based on the total weight of the aqueous spray liquor. Here and in the following ppm means part per million on a weight bases. In other words, 100 ppm corresponds to 0.01% by weight, based on the weight of the spray liquor.

In the context of the present invention, the term C₁-Cₙ denotes the number of carbon atoms a radical may have. For example, the term C₁-Cₙ alkyl relates to specific alkyl radicals within the group of linear or branched alkyl radicals having 1 to n carbon atoms. Thus, the term C₁-C₃ alkyl relates to alkyl groups within the group of linear or branched alkyl radicals having 1 to 3 carbon atoms, namely to the group consisting of methyl, ethyl, 1-propyl and 2-propyl. Thus, the term C₁-C₆ alkyl relates to alkyl groups within the group of linear or branched alkyl radicals having 1 to 6 carbon atoms, namely to the group comprising methyl, ethyl, 1-propyl, 2-propyl, 1-butyl, 2-butyl, 2-methylpropyl (isobutyl), tert-butyl, n-pentyl, 2-pentyl, 3-pentyl, 2-methyl-1-butyl, 2-methyl-2-butyl, 3-methyl-1-butyl, 3-methyl-2-butyl, n-hexyl, 2-hexyl, 3-hexyl, 2-methyl-1-pentyl, 2-methyl-2-pentyl, 3-methyl-1-pentyl, 3-methyl-2-pentyl, 4-methyl-1-pentyl, 4-methyl-2-pentyl, 2,2-dimethyl-1-butyl, 3,3-dimethyl-1-butyl, 3,3-dimethyl-2-butyl, 2,3-dimethyl-1-butyl, 2,3-dimethyl-2-butyl. The term C₂-C₆-alkylandiyl relates to saturated linear or branched bivalent alkyl radicals, including e. g. 1,1-ethandiyl, 1,2-ethandiyl, 1,2-propandiyl, 1,3-propandiyl, 1,2-butandiyl, 2,3-butandiyl, 1,4-butandiyl, 1,2-pentandiyl, 2,3-pentandiyl, 2,2-dimethyl-1,3-propandyl, 1,5-pentandiyl, 1,6 hexandiyl, 1,2-hexandiyl etc. The terms C₂-C₆-alkylandiyl and C₂-C₆-alkylene are used synonymously.

The term poly-C₂-C₆-alkyleneoxide refers to a polyether radical made of C₂-C₆-alkyleneoxide repeating units. In this context, the term C₂-C₆-alkyleneoxide refers to a radical of the formula O-Q, where Q is C₂-C₆-alkylene, in particular a radical —CH₂CH₂— or a radical —CH₂CHR⁴—, where R⁴ is C₁-C₄-alkyl. If the poly-C₂-C₆-alkyleneoxide moiety contains different C₂-C₆-alkyleneoxide repeating units may be arranged statistically, i.e. in arbitrary order, alternately or blockwise.

In the context of monomers M, the term “monoethylenically unsaturated” means that the monomer has a single ethylenically double bound, in particular in the form of a vinyl group (CH═CH₂) or a vinylidene group (C(CH₃)═CH₂). The vinyl and vinylidene groups may be bound to a saturated carbon atom of the monomer or to a carbonyl group or to an oxygen atom.

The term “monoethylenically unsaturated monocarboxylic acid having 3 to 6 C atoms” relate to carboxylic acids having a single carboxyl group (COOH), a single ethylenically unsaturated double bond and a total of 3 to 6 carbon atoms. Examples of such monoethylenically unsaturated monocarboxylic acids include, but are not limited to acrylic acid, (propenoic acid), methacrylic acid (2-methylpropenoic acid), crotonic acid (2-butenoic acid), 3-butenoic acid, 2-pentenoic acid and 2-propenyloxy acetic acid.

In the context of the present invention, the term “herbicide” relates to both the herbicide active compound, hereinafter also termed active ingredient, and to the formulation of the herbicide active ingredient.

As used herein, the terms “controlling” and “combating” are synonyms. As used herein, the terms “undesirable vegetation”, “undesirable species”, “undesirable plants”, “harmful plants”, “undesirable weeds”, or “harmfull weeds” are synonyms. The term “locus”, as used herein, means the area in which the vegetation or plants are growing or will grow, typically a field.

In the monomers M which form the copolymer CP, the monomer Ma is selected from primary amides of monoethylenically unsaturated monocarboxylic acids having 3 to 6 C atoms, in particular 3 or 4 C atoms. Preferably, the monomer Ma is selected from acrylamide and methacrylamide and mixtures thereof. In particular, the monomer Ma comprises at least 70% by weight, more particular at least 90% by weight, based on the total amount of monomers Ma, of acrylamide. Especially, the monomer Ma is acrylamide. The relative amount of the monomer Ma is in particular in the range of 65 to 99% by weight or in the range of 70 to 99% by weight or in the range of 75 to 99% by weight or in the range of 80 to 99% by weight, in particular in the range of 70 to 98.5% by weight or in the range of 75 to 98.5% by weight or in the range of 80 to 98.5% by weight or in the range of 85 to 98.5% by weight, especially in the range of 75 to 98% by weight or in the range of 80 to 98% by weight or in the range of 85 to 98% by weight, based on the total weight of ethylenically unsaturated monomers M forming the copolymer.

The monomers M may further comprise at least one monomer Mb. The monomer Mb is either a monoethylenically unsaturated monomer Mb.1 or a monomer Mb.2 Suitable monomers Mb.1 are principally any monoethylenically unsaturated sulfonic acid or a salt thereof, in particular an alkalimetal salt, such as a sodium salt or potassium salt, or an ammonium salt. Particular preference is given to monomers Mb.1, which are monomers of the formula (I) or a salt thereof:

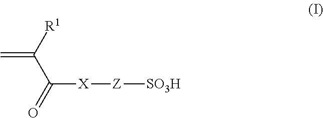

where
R¹ is H or C₁-C₃-alkyl, in particular H or methyl;
X is O or NH; and
Z is C₂-C₆-alkandiyl, in particular C₂-C₄-alkandiyl, such as 1,2-ethanidyl, 1,2-propandiyl, 1,3-propandiyl or 2-methyl-1,2-propandiyl.

Examples of monomers Mb.1 of the formula (I) are 2-acryloxyethane sulfonic acid, 2-methacryloxyethane sulfonic acid, 2-acrylamidoethane sulfonic acid, 2-methacrylamidoethane sulfonic acid, 2-acryloxypropane sulfonic acid, 2-methacryloxypropane sulfonic acid, 2-acrylamidopropane sulfonic acid, 2-methacrylamidopropane sulfonic acid, 2-acrylamido-2-methylpropane sulfonic acid and 2-acrylamido-2-methylpropane sulfonic acid and the salts thereof, in particular the sodium salts, potassium salts and ammonium salts thereof. Amongst the monomers Mb.1, particular preference is given to 2-acrylamido-2-methylpropane sulfonic acid, i.e. a monomer of the formula (I), where R¹ is H, X is NH and Z is 2-methyl-1,2-propandiyl, and the salts thereof.

Suitable monomers Mb.2 are principally any monoethylenically monomers having a quaternary ammonium group. The quaternary ammonium group may be part of a heterocycle, such as in N-alkyl-N′-vinyl imidzolium salts or in N-alkyl-N-vinylpyrrolidinium salts, or a peralkyl ammionum group. Particular preference is given to monomers Mb.2, which are monomers of the formula (II):

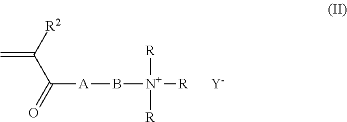

where
R is C₁-C₃-alkyl, in particular methyl or ethyl;
R² is H or C₁-C₃-alkyl, in particular H or methyl;
A is O or NH;
B is C₂-C₆-alkandiyl, in particular C₂-C₄-alkandiyl, such as 1,2-ethanidyl, 1,2-propandiyl, 1,3-propandiyl or 2-methyl-1,2-propandiyl;
Y represents a counter anion, such as chloride, sulfate or methosulfate.

Examples of monomers Mb.2 of the formula (II) are the N-(3-trimethylammoniumpropyl) acrylamide salts (dimapa-Q), N-(3-trimethylammoniumpropyl) methacrylamide salts, the 2-trimethylammoniumethyl acrylate salts, the 2-trimethylammoniumethyl methacrylate salts, the 3-trimethylammoniumpropyl acrylate salts, the 3-trimethylammoniumpropyl methacrylate salts, the N-(3-triethylammoniumpropyl) acrylamide salts, the N-(3-triethylammoniumpropyl) methacrylamide salts, the 2-triethylammoniumethyl acrylate salts, the 2-triethylammoniumethyl methacrylate salts, the 3-triethylammoniumpropyl acrylate salts, the 3-triethylammoniumpropyl methacrylate salts, in particular the chlorides, the sulfates or the methosulfates thereof.

Amongst the monomers Mb.1, particular preference is given to N-(3-trimethylammonium-propyl) acrylamide salts, in particular the chlorides, the sulfates or the methosulfates thereof, i.e. the monomers of the formula (II), where R² is H, A is NH, R is CH₃, and Z is 1,3-propandiyl, and Y represents a counter anion, such as chloride, sulfate or methosulfate.

In the copolymers CP the monomers Mb may be absent or present. The relative amount of the monomers Mb may be 0 but may also be in the range of 0.5 to 50% by weight or in the range of 0.5 to 35% by weight or in the range of 0.5 to 30% by weight, in particular in the range of 1 to 50% by weight or in the range of 1 to 30% by weight or in the range of 1 to 25% by weight or in the range of 1 to 20% by weight, more particularly in the range of 1.5 to 30% by weight or in the range of 1.5 to 25% by weight or in the range of 1.5 to 20% by weight or in the range of 1.5 to 15% by weight, and especially in the range of 2 to 25% by weight or in the range of 2 to 20% by weight or in the range of 2 to 15% by weight, based on the total weight of ethylenically unsaturated monomers M.

The monomers M may further comprise at least one monomer Mc which has a moiety bearing an ethylenically unsaturated double bond and at least one poly-C₂-C₆-alkyleneoxide moiety. The poly-C₂-C₆-alkyleneoxide moiety may have a terminal hydroxyl group (OH) or a terminal C₁-C₆-alkxoy group. Suitable moieties bearing an ethylenically unsaturated double bond may be vinyl, 2-propen-1-yl (allyl) or 2-propen-2-yl. The moiety bearing an ethylenically unsaturated double may be directly bound to the terminal oxygen atom of the poly-C₂-C₆-alkyleneoxide moiety or it may be bound via a bivalent linker. Suitable bivalent linkers are C(═O), C₁-C₆-alkandiyl or O-C₁-C₆-alkandiyl. In the poly-C₂-C₆-alkyleneoxide moiety different C₂-C₆-alkyleneoxide repeating units may be arranged statistically, i.e. in arbitrary order, alternately or blockwise. The poly-C₂-C₆-alkyleneoxide moiety of the monomers Mc preferably comprises different C₂-C₆-alkyleneoxide repeating units. Preferably, the different C₂-C₆-alkyleneoxide repeating units are arranged blockwise. In particular, the poly-C₂-C₆-alkyleneoxide moiety of the monomers Mc comprises ethylene oxide repeating units, i.e. units of the formula (EO)

—CH₂CH₂—O— (EO)

and C₃-C₆-alkyleneoxide repeating units, i.e. repeating units of the formulae (AO) and/or (AO′)

—CH₂CHR⁴—O— (AO)

—CHR⁴CH₂—O— (AO′)

where R⁴ is C₁-C₄-alkyl.

Preferably, the relative molar amounts EO repeating units to AO/AO′ repeating units is in the range of 10:1 to 1:10, in particular in the range of 5:1 to 1:5.

According to a group (a) of embodiments, preference is given to monomers Mc, which have the formula (III):

CH₂═C(R¹)—R⁵—O-(EO)ₖ-(AO/AO′)I-(EO)ₘ—R⁶ (III)

where
R¹ is H or C₁-C₃-alkyl, in particular H or methyl;
R⁵ is a covalent bond, C(═O), C₁-C₆-alkandiyl or O—C₂-C₆-alkandiyl;
R⁶ is H or C₁-C₄-alkyl, in particular H or methyl;
EO is a radical —CH₂CH₂—O—;
AO/AO′ is —CH₂CHR⁴—O— or —CHR⁴CH₂—O—, where R⁴ is C₁-C₄-alkyl, in particular methyl, ethyl or n-propyl;
k is a number in the range of 2 to 200, in particular in the range of 5 to 150, more particularly in the range of 10 to 75, especially in the range of 15 to 40 or in the range of 15 to 30;
l is a number in the range of 0 to 40, in particular in the range of 5 to 35 or 5 to 30 or 5 to 28 or 5 to 25 and especially in the range of 8.5 to 30 or 10 to 27.5 or 10 to 25 or 15 to 25;
m is a number in the range of 0 to 15, in particular the range of 0 to 10, e.g. the range of 0.5 to 15 or 0.5 to 10, more particularly in the range of 1 to 10 or 1 to 7 or 1 to 5.

In formula (III), the repeating units EO and AO/AO′ are arranged blockwise, i.e. in the form of the blocks (EO)ₖ, (AO/AO′), and (EO)ₘ, where k, I and m indicate the average number of repeating units EO and AO/AO′ within the block. The term AO/AO′ is understood that either AO or AO′ or both AO and AO′ may be present in the block (AO/AO′). In the block (AO/AO′), the radicals R⁴ in AO and AO′ have typically the same meaning. For example, in the block (AO/AO′), the meaning of R4 is either methyl or ethyl or n-propyl in all repeating units AO and AO′.

In formula (III), R⁵ is in particular C₁-C₆-alkandiyl or O—C₂-C₆-alkandiyl, more particularly CH₂ or O—(C_{n′}—H_{2n′}) wherein n is 2, 3, 4 or 5, in particular 3, 4 or 5.

According to a group (a.1) of embodiments, particular preference is given to the monomers Mc, where the variables in formula (III) have the following meanings:
R¹ is H;
R⁵ is CH₂ or O—(Co—H_{2n′}) wherein n is 2, 3, 4 or 5, in particular 3, 4 or 5;
R⁶ is H or methyl;
EO is a radical —CH₂CH₂—O—;
AO/AO′ is —CH₂CHR⁴—O— or —CHR⁴CH₂—O—, where R⁴ is methyl, ethyl or n-propyl, especially ethyl;
k is a number in the range of 10 to 75, especially in the range of 15 to 40 or in the range of 15 to 30;
l is a number in the range of 5 to 35 or 5 to 30 or 5 to 28 or 5 to 25 and especially in the range of 8.5 to 30 or 10 to 27.5 or 10 to 25 or 12 to 25;
m is a number in the range of 0.5 to 15 or 0.5 to 10, more particularly in the range of 1 to 10 or 1 to 7 or 1 to 5 and especially in the range of 1.5 to 7 or 1.5 to 5.

According to a group (a.2) of embodiments, the monomers Mc are selected from the monomers of the formula (III), where the variables in formula (III) have the following meanings:
R¹ is H;
R⁵ is O—(C₀,H_{2n′}) wherein n is 3, 4 or 5;
R⁶ is H or methyl;
EO is a radical —CH₂CH₂—O—;
AO/AO′ is —CH₂CHR⁴—O— or —CHR⁴CH₂—O—, where R⁴ is ethyl;
k is a number in the range of 15 to 40, especially in the range of 15 to 35;
l is a number in the range of 8.5 to 30, in particular in the range of 10 to 27.5 or 10 to 25, especially in the range of 12 to 25;
m is a number in the range of 0.5 to 10, more particularly in the range 1 to 7 and especially in the range of 1.5 to 5.

According to the invention, the amount of monomers Mc may be in the range of 0 to 15% by weight, in particular 0 to 8% by weight, especially 0 to 5% by weight, based on the total weight of ethylenically unsaturated monomers M. If present, the amount of the monomers Mc is typically in the range of 0.1 to 15% by weight, in particular 0.2 to 8% by weight, especially 0.5 to 5% by weight, based on the total weight of ethylenically unsaturated monomers M.

According to a particular preferred group (1) of embodiments, the monomers M forming the copolymer CP comprise from 0.5 to 50% by weight or 0.5 to 35% by weight or 0.5 to 30% by weight of at least one monomer Mb.1, in particular at least one monomer Mb.1 which is selected from the monomers of the formula (I). In this particular group (1) of embodiments, the monomer Mb is in particular 2-acrylamido-2-methylpropane sulfonic acid or a salt thereof, in particular a sodium potassium or ammonium salt thereof. In the particular group (1) of embodiments the amount of monomers Mb.1 is in particular in the range of 1 to 50% by weight or in the range of 1 to 35% by weight or in the range of 1 to 30% by weight or in the range of 1 to 25% by weight or in the range of 1 to 20% by weight, more particularly in the range of 1.5 to 30% by weight or in the range of 1.5 to 25% by weight or in the range of 1.5 to 20% by weight or in the range of 1.5 to 15% by weight, and especially in the range of 2 to 25% by weight or in the range of 2 to 20% by weight or in the range of 2 to 15% by weight, based on the total weight of ethylenically unsaturated monomers M.

In a particular subgroup (1.a) of group (1) of embodiments, the monomers M forming the copolymer CP essentially consist of the monomer Ma and the monomer Mb.1. In this particular subgroup (1.a) of embodiments, the monomers M forming the copolymer essentially consist of
a) 50 to 99.5% by weight, in particular 65 to 99% by weight or 70 to 99% by weight or 75 to 99% by weight or 80 to 99% by weight, more particularly of 70 to 98.5% by weight or 75 to 98.5% by weight or 80 to 98.5% by weight or 85 to 98.5% by weight, especially 75 to 98% by weight or 80 to 98% by weight or 85 to 98% by weight or 80 to 95% by weight or 85 to 95% by weight, based on the total weight of the ethylenically unsaturated monomers M, of at least one monomer Ma, which is preferably selected from acrylamide, methacrylamide and mixtures thereof; and
b) 0.5 to 50% by weight, in particular 1 to 35% by weight or 1 to 30% by weight or 1 to 25% by weight or 1 to 20% by weight, more particularly 1.5 to 30% by weight or 1.5 to 25% by weight or 1.5 to 20% by weight or 1.5 to 15% by weight, especially 2 to 25% by weight or 2 to 20% by weight or 2 to 15% by weight or 5 to 20% by weight or 5 to 15% by weight, based on the total weight of the ethylenically unsaturated monomers M, at least one monomer Mb.1, which is preferably selected from the monomers of the formula (I) and the salts thereof.

In the particular subgroup (1.a) of group (1) of embodiments, the monomers M forming the copolymer CP preferably essentially consist of
a) 50 to 99.5% by weight, in particular 65 to 99% by weight or 70 to 99% by weight or 75 to 99% by weight or 80 to 99% by weight, more particularly of 70 to 98.5% by weight or 75 to 98.5% by weight or 80 to 98.5% by weight or 85 to 98.5% by weight, especially 75 to 98% by weight or 80 to 98% by weight 85 to 98% by weight or or 80 to 95% by weight or 85 to 95% by weight, based on the total weight of the ethylenically unsaturated monomers M, of acrylamide; and
b) 0.5 to 50% by weight, in particular 1 to 35% by weight or 1 to 30% by weight or 1 to 25% by weight or 1 to 20% by weight, more particularly 1.5 to 30% by weight or 1.5 to 25% by weight or 1.5 to 20% by weight or 1.5 to 15% by weight, especially 2 to 25% by weight or 2 to 20% by weight or 2 to 15% by weight or 5 to 20% by weight or 5 to 15% by weight, based on the total weight of the ethylenically unsaturated monomers M, at least one monomer Mb.1, which is preferably selected from 2-acrylamido-2-methylpropane sulfonic acid and the salts thereof.

In another particular subgroup (1.b) of group (1) of embodiments, the monomers M forming the copolymer CP essentially consist of the monomer Ma, the monomer Mb.1 and the monomer Mc. In this particular subgroup (1.b) of embodiments, the monomers M forming the copolymer essentially consist of
a) 50 to 99.4% by weight, in particular 65 to 98.8% by weight, more particularly 70 to 98.3% by weight, especially 75 to 97.5% by weight or 80 to 97.5% by weight or 80 to 97.5% by weight, based on the total weight of the ethylenically unsaturated monomers M, of at least one monomer Ma, which is preferably selected from acrylamide, methacrylamide and mixtures thereof;
b) 0.5 to 49.9% by weight, in particular 1 to 34.8% by weight, more particularly 1.5 to 29.8% by weight, especially 2 to 24.5% by weight or 2 to 19.5% by weight or 4 to 19.5% by weight, based on the total weight of the ethylenically unsaturated monomers M, at least one monomer Mb.1, which is preferably selected from the monomers of the formula (I) and the salts thereof;
c) 0.1 to 15% by weight, in particular 0.2 to 8% by weight, especially 0.5 to 5% by weight, of at least one monomer Mc, in particular a monomer Mc of the formula (III) and especially at least one monomer Mc of the groups a.1 or a.2 of embodiments;
   where the total amount of monomers Ma and Mb is at least 85% by weight, in particular at least 92% by weight and especially at least 95% by weight, based on the total weight of ethylenically unsaturated monomers M, and where the total amount monomers Mb and Mc is from 0.6 to 50% by weight, in particular from 1.2 to 35% by weight or 1.2 to 30% by weight, especially 2.5 to 25% by weight or 2.5 to 20% by weight or 4.5 to 20% by weight, based on the total weight of ethylenically unsaturated monomers M.

In the particular subgroup (1.b) of group (1) of embodiments, the monomers M forming the copolymer CP preferably essentially consist of
a) 50 to 99.4% by weight, in particular 65 to 98.8% by weight, more particularly of 70 to 98.3% by weight, especially 75 to 97.5% by weight or 80 to 97.5% by weight or 80 to 97.5% by weight, based on the total weight of the ethylenically unsaturated monomers M, of acrylamide;
b) 0.5 to 49.9% by weight, in particular 1 to 34.8% by weight, more particularly 1.5 to 29.8% by weight, especially 2 to 24.5% by weight or 2 to 19.5% by weight or 4 to 19.5% by weight, based on the total weight of the ethylenically unsaturated monomers M, at least one monomer Mb.1, which is preferably selected from 2-acrylamido-2-methylpropane sulfonic acid and the salts thereof;
c) 0.1 to 15% by weight, in particular 0.2 to 8% by weight, especially 0.5 to 5% by weight, of at least one monomer Mc of the groups a.1 or a.2 of embodiments;
   where the total amount of monomers Ma and Mb is at least 85% by weight, in particular at least 92% by weight and especially at least 95% by weight, based on the total weight of ethylenically unsaturated monomers M, and where the total amount monomers Mb and Mc is from 0.6 to 50% by weight, in particular from 1.2 to 35% by weight or 1.2 to 30% by weight, especially 2.5 to 25% by weight or 2.5 to 20% by weight or 4.5 to 20% by weight, based on the total weight of ethylenically unsaturated monomers M.

According to another group (2) of embodiments, the monomers M forming the copolymer CP comprise at least one monomer Ma and at least one monomer Mc in the above amounts, where the monomers Mc are preferably selected from the monomers of the formula (III) and especially at least one monomer Mc of the groups a.1 or a.2 of embodiments.

In a subgroup (2a) of group (2) of embodiments the monomers M forming the copolymer CP essentially consist of the monomer Ma and the monomer Mc. In this subgroup (2a) of embodiments, the monomers M preferably essentially consist of
a) 95 to 99.5% by weight, in particular 92 to 99.5% by weight, especially 95 to 99.5% by weight or 95 to 99.3% by weight, based on the total weight of the ethylenically unsaturated monomers M, of at least one monomer Ma, which is preferably selected from acrylamide, methacrylamide and mixtures thereof; and
b) 0.5 to 15% by weight, in particular 0.5 to 8% by weight, especially 0.5 to 5% by weight or 0.7 to 5% by weight, based on the total weight of the ethylenically unsaturated monomers M, at least one monomer Mc, which is preferably selected from the monomers of the formula (III) and especially at least one monomer Mc of the groups a.1 or a.2 of embodiments.

In this particular subgroup (2.a) of embodiments, the monomers M forming the copolymer CP preferably essentially consist of
a) 85 to 99.5% by weight, in particular 92 to 99.5% by weight, especially 95 to 99.5% by weight or 95 to 99.3% by weight, based on the total weight of the ethylenically unsaturated monomers M, of acrylamide; and
b) 0.5 to 15% by weight, in particular 0.5 to 8% by weight, especially 0.5 to 5% by weight or 0.7 to 5% by weight, based on the total weight of the ethylenically unsaturated monomers M, at least one monomer Mc, which is preferably selected from the monomers of the groups a.1 or a.2 of embodiments.

According to a further group (3) of embodiments, the monomers M forming the copolymer CP comprise at least one monomer Ma and at least one monomer Mb.2 in the above amounts, where the monomers Mb are preferably selected from the monomers of the formula (II) and especially from N-(3-trimethylammoniumpropyl) acrylamide salts, in particular the chlorides, the sulfates or the methosulfates thereof. In this further group (3) of embodiments, the monomers M may comprise a monomer Mc in the amount given above.

In a subgroup (3a) of group (3) of embodiments, the monomers M preferably essentially consist of
a) 65 to 99.5% by weight, in particular 82 to 99% by weight, especially 90 to 98.5% by weight, based on the total weight of the ethylenically unsaturated monomers M, of at least one monomer Ma, which is preferably selected from acrylamide, methacrylamide and mixtures thereof;
b) 0.2 to 20% by weight, in particular 0.5 to 10% by weight, especially 1 to 5% by weight, based on the total weight of the ethylenically unsaturated monomers M, at least one monomer Mb.2, which is preferably selected from the monomers of the formula (II) and the salts thereof;
c) 0.1 to 15% by weight, in particular 0.2 to 8% by weight, especially 0.5 to 5% by weight, of at least one monomer Mc, in particular a monomer Mc of the formula (III) and especially at least one monomer Mc of the groups a.1 or a.2 of embodiments;
   where the total amount of monomers Ma and Mb is at least 85% by weight, in particular at least 92% by weight, and especially at least 95% by weight, based on the total weight of ethylenically unsaturated monomers M, and where the total amount monomers Mb and Mc is from 0.5 to 35% by weight, in particular from 1 to 18% by weight, especially 1.5 to 10% by weight, based on the total weight of ethylenically unsaturated monomers M.

In the particular subgroup (3.a) of group (3) of embodiments, the monomers M forming the copolymer CP preferably essentially consist of
a) 65 to 99.5% by weight, in particular 82 to 99% by weight, especially 90 to 98.5% by weight, based on the total weight of the ethylenically unsaturated monomers M, of acrylamide;
b) 0.2 to 20% by weight, in particular 0.5 to 10% by weight, especially 1 to 5% by weight, based on the total weight of the ethylenically unsaturated monomers M, at least one monomer Mb.2, which is preferably selected from N-(3-trimethylammoniumpropyl) acrylamide salts, in particular the chlorides, the sulfates or the methosulfates thereof;
c) 0.1 to 15% by weight, in particular 0.2 to 8% by weight, especially 0.5 to 5% by weight, of at least one monomer Mc of the groups a.1 or a.2 of embodiments;
   where the total amount of monomers Ma and Mb is at least 85% by weight, in particular at least 92% by weight, and especially at least 95% by weight, based on the total weight of ethylenically unsaturated monomers M, and where the total amount monomers Mb and Mc is from 0.5 to 35% by weight, in particular from 1 to 18% by weight, especially 1.5 to 10% by weight, based on the total weight of ethylenically unsaturated monomers M.

In a subgroup (3b) of group (3) of embodiments, the monomers M preferably essentially consist of
d) 95 to 99.5% by weight, in particular 95 to 99% by weight, especially 95 to 98.5% by weight, based on the total weight of the ethylenically unsaturated monomers M, of at least one monomer Ma, which is preferably selected from acrylamide, methacrylamide and mixtures thereof;
e) 0.5 to 5% by weight, in particular 1 to 5% by weight, especially 1.5 to 5% by weight, based on the total weight of the ethylenically unsaturated monomers M, at least one monomer Mb.2, which is preferably selected from the monomers of the formula (II) and the salts thereof.

As regards the groups (1), (2) and (3) of embodiments and the particular subgroups (1.a), (1.b), (2a), (3a) and (3b) of groups (1), (2) and (3) of embodiments, the term, “essentially consist” of means that the total amount of the monomers Ma and Mb.1 or Mb.2 and, if present, Mc is at least 99% by weight, in particular at least 99.5% by weight or at least 99.9% by weight and especially 100% by weight, based on the total weight of the ethylenically unsaturated monomers M which form the copolymer CP.

The copolymer CP preferably has a weight average molecular weight Mw of at least 100,000 g/mol, in particular at least 250,000 g/mol, more preferably at least 500,000, even more preferably at least 750,000 g/mol, especially at least 1,000,000 g/mol, as determined by gel permeation chromatography (GPC), also termed size exclusion chromatography (SEC). The weight average molecular weight may be very high, e.g. up to 30,000,000 g/mol, in particular up to 20,000,000 g/mol, as determined by GPC/SEC. GPC/SEC is typically carried out using a series of suitable columns and water at pH 7 as an eluent and using polyacrylic acid sodium salt or poly(methy acrylic acid) sodium salt of known molecular weight as a standard.

The molecular weight can also be estimated from the intrinsic viscosity [η] of the copolymer CP by using the following Mark-Houwink equation (1):

$$[ η ] = 6.98 \times {10}^{- 4} {M}_{w}^{0.91} \qquad ( 1 )$$

where M_{w} is the weight average molecular weight of the copolymer CP and where [η] is given in cm³/g. The intrinsic viscosity [η] of the copolymer CP in the form of its sodium salt is frequently at least 50 cm³/g, in particular at least 100 cm³/g, preferably at least 150 and especially at least 200 cm³/g as determined at 30° C. in 0.5 M aqueous solution of sodium chloride.

For this, the intrinsic viscosity [η] of the copolymer CP can determined according to the method described by H. Zhang and Y. Feng, J. Appl. Polym. Sci. 2021, 138:e50850 (DOI: 10.1002/app.50850), e. g. by measuring the specific viscosity nₛₚ of aqueous solutions of the copolymer CP in 0.5 molar aqueous solutions of the copolymer CP at different concentrations, e.g. in the range of 0.05 to 0.5 mg/ml and extrapolating the values to infinite dilution using capillary viscometers.

The copolymers CP are known as flocculants or as thickeners, e.g. from WO 2014/095608, WO 2014/095621 and WO 2015/086468 or can be prepared by analogy to the methods described therein. Likewise, the monomers Mc are known from WO 2014/095608, WO 2014/095621 and WO 2015/086468 or can be prepared by analogy to the methods described therein.

Frequently, the copolymers CP described herein are obtainable by a free-radical aqueous solution copolymerization of monomers M.

The term free-radical polymerization is understood that the polymerization of the ethylenically unsaturated monomers M is performed in the presence of a polymerization initiator, which, under polymerization conditions, forms radicals, either by thermal decomposition or by a redox reaction. A solution polymerization means that a solution of the monomers in a solvent, which is also capable of dissolving the copolymers, is polymerized by a free radical polymerization, i.e. in the presence of a polymerization initiator.

Suitable solvents for performing the solution polymerization include water and polar organic solvents and mixtures thereof with water. Suitable polar organic solvents are those, which are at least partially miscible with water and which preferably are miscible with water to an extent of at least 100 g/L at 20° C. and ambient pressure. Suitable organic solvents include, but are not limited to, C₁-C₄-alkanols, such as methanol, ethanol, propanol, isopropanol (=2-propanol), n-butanol, sec-butanol (=2-butanol) or isobutanol, dimethyl sulfoxide, ethyl acetate. Preferred organic solvents are selected from C₁-C₄-alkanols, such as methanol, ethanol, propanol, isopropanol, n-butanol, sec-butanol or isobutanol, preferably isopropanol or sec-butanol. In particular, solvents for performing the solution polymerization are selected from water and mixtures of water and one or more C₁-C₄-alkanols. Especially, the solvent used for the free-radical polymerization of the monomers forming the copolymer CP contains at least 50% by volume, in particular at least 70% by volume of water, based on the total amount of solvent. In particular, water is the sole solvent.

The polymerization of the monomers forming the copolymer or its precursor is preferably a free-radical copolymerization and thus triggered by means of a free-radical polymerization initiator (free-radical initiator). These may in principle be peroxides or azo compounds. Of course, redox initiator systems may also be used.

Suitable peroxides may, in principle, be inorganic peroxides, such as hydrogen peroxide or peroxodisulfates, such as the mono- or di-alkali metal or ammonium salts of peroxodisulfuric acid, for example the mono- and disodium, -potassium or ammonium salts, or organic peroxides, e.g. peroxy acids and esters of peroxy acids, such as diisopropyl peroxydicarbonate, t-amyl perneodecanoate, t-butyl perneodecanoate, t-butyl perpivalate, t-amyl perpivalate, bis(2,4-dichlorobenzoyl) peroxide, diisononanoyl peroxide, didecanoyl peroxide, dioctanoyl peroxide, dilauroyl peroxide, bis(2-methylbenzoyl) peroxide, disuccinoyl peroxide, diacetyl peroxide, dibenzoyl peroxide, t-butyl per-2-ethylhexanoate, t-butyl-2-ethylhexanoate, bis(4-chlorobenzoyl) peroxide, t-butyl perisobutyrate, t-butyl permaleate, 1,1-bis(t-butyl peroxy)cyclohexane, t-butyl peroxyisopropylcarbonate, t-butyl perisononanoate, t-butyl peracetate, t-amyl perbenzoate, 3-(t-butylperoxy)-3-phenylphthalide or t-butyl perbenzoate, alkyl and cycloalkyl peroxides, such as 1,1-bis(t-butyl peroxy)-3,5,5-trimethylcyclohexane, 2,2-bis(t-butylperoxy)butane (di-t-butyl peroxide), 2,2-bis-10-(t-butylperoxy)propane, 2,5-dimethyl-2,5-bis(t-butylperoxy)hexane, di(t-amyl) peroxide, α,α′-bis(t-butylperoxyisopropyl)benzene, 3,5-bis(t-butylperoxy)-3,5-dimethyl-1,2-dioxolane, di(t-butyl) peroxide, 2,5-dimethyl-2,5-bis(t-butylperoxy)hexyne, 3,3,6,6,9,9-hexamethyl-1,2,4,5-tetraoxacyclononane, p-menthane hydroperoxide, pinane hydroperoxide, aromatic peroxides, such as dicumyl peroxide, diisopropylbenzene, mono-α-hydroperoxide or cumene hydroperoxide. A suitable peroxide may also be hydrogen peroxide.

Typical azo initiators are, for example, 4,4′-azobis-4-cyanovaleric acid (ACVA), 2,2′-azobis(2-methylpropionamidine) dihydrochloride, 2,2′-azobis(2-methylpropionitrile) (AIBN), 2,2′-azobis(2-methylbutanenitrile), 2,2′-azobis(2,4-dimethylvaleronitrile), 1,1′-azobis(cyanocyclohexane), 1,1′-azobis(N,N-dimethylformamide), 2,2′-azobis(2-methylbutyronitrile), 2,2′-azobis(4-methoxy-2,4-dimethylvaleronitrile), 2,2′-azobis(2,4,4-trimethylpentane), 2,2′-azobisisobutyronitrile, 2,2′-azobis(2-methylbutyronitrile), 2,2′-azobis(2,4-dimethylvaleronitrile), 2,2′-azobis(4-methoxy-2,4-dimethylvaleronitrile), 1,1′-azobis(1-cyclohexanecarbonitrile), 2,2′-azobis(isobutyramide) dihydrate, 2-phenylazo-2,4-dimethyl-4-methoxyvaleronitrile, dimethyl 2,2′-azobisisobutyrate, 2-(carbamoylazo)isobutyronitrile, 2,2′-azobis(2,4,4-trimethylpentane), 2,2′-azobis(2-methyl propane), 2,2′-azobis(N,N′-dimethyleneisobutyramidine), 2,2′-azobis(N,N′-dimethylene-isobutyramidine) hydrochloride, 2,2′-azobis(2-amidinopropane), 2,2′-azobis(2-amidinopropane) hydrochloride, 2,2′-azobis(2-methyl-N-[1,1-bis(hydroxymethyl)ethyl]propionamide), azobis(2-amidopropane) dihydrochloride or 2,2′-azobis(2-methyl-N[1,1-bis(hydroxymethyl)-2-hydroxyethyl]propionamide).

Typical redox initiators are, for example, mixtures of an oxidizing agent, such as hydrogen peroxide, peroxodisulfates or aforementioned peroxide compounds and a reducing agent. Corresponding reducing agents, which may be used are sulfur compounds with a low oxidation state, such as ammonium sulfite and alkali metal sulfites, for example potassium and/or sodium sulfite, ammonium bisulfite and alkali metal hydrogensulfites, for example potassium and/or sodium hydrogensulfite, ammonium metabisulfite and alkali metal metabisulfites, for example potassium and/or sodium metabisulfite, formaldehydesulfoxylates, for example potassium and/or sodium formaldehyde sulfoxylate, ammonium salts and alkali metal salts, specifically potassium and/or sodium salts of aliphatic sulfinic acids and alkali metal hydrogensulfides, for example potassium and/or sodium hydrogensulfide, salts of polyvalent metals, in particular Co(II) salts and Fe(II) salts, such as iron(II) sulfate, iron(II) ammonium sulfate or iron(II) phosphate, but also dihydroxymaleic acid, benzoin and/or ascorbic acid, and reducing saccharides, such as sorbose, glucose, fructose and/or dihydroxyacetone.

Preferably, the free-radical polymerization initiator comprises an inorganic peroxide, in particular a peroxodisulfate, such as the mono- or di-alkali metal or ammonium salts of peroxodisulfuric acid. In particular, the free-radical polymerization initiator is a redox initiator, which comprises an inorganic peroxide, in particular a peroxodisulfate, such as the mono- or di-alkali metal or ammonium salts of peroxodisulfuric acid as the oxidizing agent. In these redox initiators, the reducing agent is preferably selected from the group of sulfur compounds with a low oxidation state, such as alkali metal sulfites, for example potassium and/or sodium sulfite, alkali metal hydrogensulfites, for example potassium and/or sodium hydrogensulfite, alkali metal metabisulfites, for example potassium and/or sodium metabisulfite, formaldehydesulfoxylates, for example potassium and/or sodium formaldehydesulfoxylate, alkali metal salts, specifically potassium and/or sodium salts of aliphatic sulfinic acids and alkali metal hydrogensulfides, for example potassium and/or sodium hydrogensulfide. In these redox initiators, the molar amount of the reducing agent will exceed the molar amount of the oxidizing agent. In particular, the molar ratio of the reducing agent to the oxidizing agent is in the range from 1.5:1 to 100:1.

The molecular weight of the copolymer can be adjusted by choosing a proper relative amount of the free-radical polymerization initiator with respect to the monomers to be polymerized. As a rule of thumb, increasing the relative amount of the free-radical polymerization initiator will result in a decrease of the molecular weight, while decreasing the relative amount of the free-radical polymerization initiator will result in an increased molecular weight. If the free-radical polymerization initiator is selected from redox initiators, an increase of the molar ratio of the reducing agent to the oxidizing agent will likewise result in a decreased molecular weight and vice versa. Typically, the amount of the free-radical polymerization initiator is in the range of 0.02 to 20 mmol, in particular 0.5 to 5.0 mmol per 1 mol of monomers to be copolymerized. In case of redox initiators, these ranges refer to the oxidizing agent.

The polymerization of the monomers forming the copolymer CP or its precursor is usually conducted at temperatures in the range from 25 to 150° C. Temperatures employed are frequently in the range from 40 to 120° C., in particular in the range from 50 to 110° C. and especially in the range from 60 to 90° C.

The polymerization of the monomers forming the copolymer or its precursor can be carried out at a pressure of less than, equal to or greater than 1 atm (atmospheric pressure), and so the polymerization temperature may exceed 100° C. and may be up to 150° C. Polymerization of the monomers is normally performed at ambient pressure, but it may also be performed under elevated pressure. In this case, the pressure may assume values of 1.1 to 15 bar (absolute) or even higher values. Frequently, the free-radical polymerization of the invention is conducted at ambient pressure (about 1 atm) with exclusion of oxygen, for example under an inert gas atmosphere, for example under nitrogen or argon.

The polymerization of the monomers forming the copolymer or its precursor can be carried out e.g. by a batch or semi-batch procedure or by a continuous procedure. In the batch procedure, the monomers to be polymerized and optionally the solvent used in the polymerization procedure is charged to a reaction vessel, while the majority or the total amount of the polymerization initiator is added to the reaction vessel in the course of the polymerization reaction. In a semi batch procedure, at least a portion of the total amount of the free-radical polymerization initiator and solvent and optionally a small portion of the monomers are charged to the reaction vessel and the majority of monomers to be polymerized are added to the reaction vessel in the course of the polymerization reaction. In a continuous process, the monomers, the polymerization initiator and the solvent are continuously added to a reaction vessel, and the obtained copolymer is continuously discharged from the polymerization vessel. Preferably, the polymerization of the monomers forming the copolymer or its precursor is conducted as a semi-batch procedure. In particular, at least 90% of the monomers to be polymerized are added to the reaction vessel in the course of the polymerization reaction.

In particular, the copolymerization of the monomers M is carried out as a gel polymerization in water as the coherent phase. Gel polymerization can be carried out as described for the solution polymerization as a free radical polymerization in water or an aqueous solvent. However, higher monomer concentration are present at the beginning of the gel polymerization, e. g. monomer concentrations in the range of 20 to 50% by weight. Details for gel polymerization and suitable reactors are described in WO 2014/095608, WO 2014/095621 and WO 2015/086468.

The polymerization of the monomers forming the copolymer or its precursor may also include a step, where any residual monomers are removed e.g. by physical means, such as distillation or by chemical means, i.e. by forced radical polymerization, e.g. by using a second free-radical polymerization initiator, which is added to the polymerization reaction after at least 90% of the monomers to be polymerized have been reacted. Preferably, the second free-radical polymerization initiator is a hydroperoxide or a persulfate.

The copolymers CP are useful for increasing the efficacy of a herbicide, i.e. it increases or enhances the herbicidal activity of a herbicide active compound. For this, the copolymer CP is applied together with the herbicide, in particular via an aqueous spray liquor. As mentioned above, the amount of the copolymer CP in the aqueous spray liquor is preferably in the range of 5 to 500 ppm, in particular in the range of 10 to 300 ppm, more particularly in the range of 10 to 200 ppm, especially the range of 10 to 100 ppm, based on the total weight of the aqueous spray liquor. The amount of the herbicide in the aqueous spray liquor depends of its application rate, which is typically in the range from 10 g/ha to 2 kg/ha, in particular in the range of 20 to 1.2 kg/h, calculated as active herbicide compound. Frequently, the concentration of the herbicide in the aqueous spray liquor is in the range of 0.01 to 1.5% by weight, calculated as the active herbicide compound.

The aqueous spray liquor may have any pH value which is acceptable for agricultural purposes. Preferably, the aqueous spray liquor has a pH in the range of pH 4 to pH 9, as determined at 25° C.

Suitable herbicide active compounds for the use and the method of the present invention are from the herbicide classes of the Compendium of Pesticide Common Names (https://pesticidecompendium.bcpc.org/class_herbicides.html), namely:
amide herbicides, including also anilide herbicides, arylalanine herbicides, chloroacetanilide herbicides, sulfoanilide herbicides, sulfonamide herbicides, thioamide herbicides,
aromatic acid herbicides, including also benzoic acid herbicides, pyrimidinyloxybenzoic acid herbicides, pyrimidinylthiobenzoic acid herbicides, phthalic acid herbicides and picolinic acid herbicides,
arylcyclohexanedione herbicides,
bezofuranly alkylsulfnate herbicides,
benzothiazole herbicides,
carbamate herbicides, including also carbanilate herbicides,
cyclohexene oxime herbicides,
cyclopropylisoxazle herbicides,
dicarboximide herbicides,
dinitroaniline herbicides,
diphenylether herbicdes, including also nitrophenyl ether herbicides,
dithiocarbamate herbicides,
imidazolinone herbicides,
imide herbicides,
nitrile herbicides,
organophosphorous herbicides,
oxadiazolone herbicides,
oxazole herbicides,
phenoxy herbicides, including also phenoxyacetic herbicides, phenoxypropionic herbicides and phenoxybutyric herbicides,
aryloxyphenoxypropionic herbicdes,
phenylenediamine herbicides,
pyrazole herbicides, including also benzoylpyrazole herbicides, and phenylpyrazole herbicides,
pyridazine herbicides,
pyridazinone herbicides,
pyridine herbicides,
pyrimidinediamine herbicides,
pyrimidinyloxyybenzylamine herbicides,
quaternary ammonium herbicides
thiocarbamate herbicides
thiocarbonate herbicides,
thiourea herbicdes,
triazine herbicides, including also chlorotriazine herbicides, fluoroalkyltriazine herbicides, methoxytriazine herbicides, methylthiotriazine herbicides,
triazinone herbicides,
triazole herbicides,
triazolone herbicides,
triazolopyrimidine herbicides,
uracil herbicides and phenyluracil herbicides,
urea herbicides, including also phenylurea herbicides, sulfonylurea herbicides, with subclasses of pyrimidinylsulfonylurea herbicides and triazinylsuflonylurea herbicides, thiadiazolylurea herbicides,
unclassified herbicides, such as azafenidin, bentazone, benzobicylcon, bicyclpyrone, chlorfenac, chlorfenprop, chlorflurazole, chlroflurenol, cinmethyline, endothal, fluoromidine, fluridone, fluorochloridone, flurtamone, fluthiacet,

Preferably, the herbicide is an organic herbicide compound which is selected from the following groups (i) to (viii) of herbicide compounds and combinations thereof:
(i) herbicides of the group of glutamine synthetase inhibitors (Class 10 of the classification according to HRAC (Herbicide Resistance Action Committee);
(ii) herbicides of the group of 5-enolpyruvylshikimate-3-phosphate synthase inhibitors (EPSP synthase inhibitors) (Class 9 of the classification according to HRAC);
(iii) herbicides of the group of auxin agonists (Class 4 of the classification according to HRAC);
(iv) herbicides of the group of protoporphyrinogen oxidase inhibitors (PPO inhibitors) (Class 14 of the classification according to HRAC);
(v) herbicides of the group of acetolactate synthase inhibitors (ALS inhibitors) (Class 2 of the classification according to HRAC);
(vi) herbicides of the group of photosystem II inhibitors (PS II inhibitors) (Classes 5 and 6 of the classification according to HRAC);
(vii) herbicides of the group of hydroxyphenylpyruvate dioxygenase inhibitors (HPPD inhibitors) (Class 27 of the classification according to HRAC);
(viii) herbicides of the group of acetyl-CoA carboxylase inhibitors (ACCase inhibitors) (Class 1 of the classification according to HRAC).

Suitable herbicides of groups (i) to (viii) are known and can be chosen by their mode of action as defined by the Herbicide Resistance Action Committee. Further details can be taken from: https://hracglobal.com/tools/classification-lookup/?s=&mode=9796&letter=&number=#classificationLookup

Examples of herbicides of group (i) are glufosinate and bialaphos and the salts thereof.

Examples of herbicides of group (ii) are glyphosate and the salts thereof.

Examples of herbicides of group (iii) are
benzoic acids, such as dicamba, TBA and chloramben and the salts and esters thereof;
phenoxy herbicides, such as 2,4,5-T, 2,4-D, 2,4-DB, clomeprop, dichlorprop, fenoprop, MCPA, MCPB, and the salts and esters thereof;
pyridinecarboxylic acids (also termed picolinic acid herbicides), such as aminopyralid, clopyralid, florpyrauxifen, halauxifen, picloram, fluroxypyr triclopyr, aminocyclopyrachlor, and the salts and esters thereof;
phenylacetic acids, such as chlorfenac and chlorfenprop,
quinoline carboxylic acids, such as quinclorac and quinmerac, and the salts and esters thereof.

Preferred herbicides of group (iii) are the benzoic acid herbicides, in particular dicamba and its salts, the phenoxy herbicides, in particular 2,4-D and its salts, and the quinolone carboxylic acids, in particular quinclorac and the salts thereof.

Examples of herbicides of group (iv) are azafenidin, butafenacil, carfentrazone, carfentrazone-ethyl, cinidon-ethyl, flumiclorac, flumiclorac-pentyl, flumioxazin, fluthiacet, fluthiacet-methyl, oxadiargyl, oxadiazon, pentoxazone, profluazol saflufenacil, sulfentrazone, thidiazimin, tiafenacil, trifludimoxazin, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7), 2-(2,2,7-trifluoro-3-oxo-4-prop-2-ynyl-3,4-dihydro-2Hbenzo[1,4]oxazin-6-yl)-4,5,6,7-tetrahydro-isoindole-1,3-dione (CAS 1300118-96-0), 1-methyl-6-trifluoromethyl-3-(2,2,7-trifluoro-3-oxo-4-prop-2-ynyl-3,4-dihydro-2Hbenzo[1,4]oxazin-6-yl)-1H-pyrimidine-2,4-dione (CAS 1304113-05-0), 3-[7-chloro-5-fluoro-2-(trifluoromethyl)-1H-benzimidazol-4-yl]-1-methyl-6-(trifluoromethyl)-1H-pyrimidine-2,4-dione (CAS 212754-02-4), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-acetic acid methyl ester (CAS 2158274-96-3), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy] acetic acid ethyl ester (CAS 2158274-50-9), methyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2271389-22-9), ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-aceticacid methyl ester (CAS 2158275-73-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy] acetic acid ethyl ester (CAS 2158274-56-5), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-N-(methylsulfonyl)-acetamide (CAS 2158274-53-2), and 2-[[3-[[3-chloro-6-[3,6-dihydro-3-methyl-2,6-dioxo-4-(trifluoromethyl)-1 (2H)-pyrimidinyl]-5-fluoro-2-pyridinyl]oxy]-2-pyridinyl]oxy]-N-(methylsulfonyl)-acetamide (CAS 2158276-22-1).

Amongst herbicides of the group of PPO inhibitors preference is given to the following group of compounds: flumioxazin, carfentrazone, sulfentrazone, butafenacil, acifluorfen, fomesafen, lactofen, oxyfluorfen, saflufenacil and trifludimoxazin, and their agriculturally acceptable salts and esters, such as in particular fomesafen-sodium, acifluorfen-sodium, acifluorfen-methyl, carfentrazone-ethyl. Particular preference is given to saflufenacil, fomesafen or a salt thereof, such as fomesafen sodium, and flumioxazin.

Examples of herbicides of group (v) are
triazolopyrimidine herbicides, e.g. cloransulam, diclosulam, florasulam, flumetsulam, metosulam, penoxsulam and pyroxsulam, and the salts and esters thereof such as cloransulam-methyl;
sulfonylamino-carbonyl-triazolinone herbicides, also termed sulfonanilides, e.g. flucarbazone, propoxycarbazone, thiencarbazone and triafamone, and the salts and esters thereof such as flucarbazone-sodium, propoxycarbazone-sodium and thiencarbazone-methyl;
pyrimidinyl(thio) benzoate herbicides, such as bispyribac, pyribenzoxim, pyriftalid, pyrimisulfan, pyrithiobac, pyriminobac, the salts and esters thereof such as bispyribac-sodium, pyrithiobac-sodium and pyriminobac-methyl, as well as 4-[[[2-[(4,6-dimethoxy-2-pyrimidinyl)oxy]phenyl]methyl]amino]-benzoic acid-1-methylethyl ester (CAS 420138-41-6), 4-[[[2-[(4,6-dimethoxy-2-pyrimidinyl)oxy]phenyl]methyl]amino]-benzoic acid propyl ester (CAS 420138-40-5) and N-(4-bromophenyl)-2-[(4,6-dimethoxy-2-pyrimidinyl)oxy]benzenemethanamine (CAS 420138-01-8);
sulfonylurea herbicdes, e. g. amidosulfuron, azimsulfuron, bensulfuron, chlorimuron, chlorsulfuron, cinosulfuron, cyclosulfamuron, ethametsulfuron, ethoxysulfuron, flazasulfuron, flucetosulfuron, flupyrsulfuron, foramsulfuron, halosulfuron, imazosulfuron, iodosulfuron, iofensulfuron, mesosulfuron, metazosulfuron, metsulfuron, nicosulfuron, orthosulfamuron, oxasulfuron, primisulfuron, propyrisulfuron, prosulfuron, pyrazosulfuron, rimsulfuron, sulfometuron, sulfosulfuron, thifensulfuron, triasulfuron, tribenuron, trifloxysulfuron, triflusulfuron and tritosulfuron, and the esters and salts thereof such as bensulfuron-methyl, chlorimuron-ethyl, ethametsulfuron-methyl, flupyrsulfuron-methyl-sodium, halosulfuron-methyl, iodosulfuron-methyl-sodium, iofensulfuron-sodium, metsulfuron-methyl, primisulfuron-methyl, pyrazosulfuron-ethyl, sulfometuron-methyl, thifensulfuron-methyl, tribenuron-methyl and triflusulfuron-methyl;
imidazolinone herbicides, e. g. imazamethabenz, imazamox, imazapic, imazapyr, imazaquin and imazethapyr, and the salts and esters thereof.

Preferred herbicides of group (v) are
the triazolopyrimidine herbicides, in particular cloransulam, and the salts and esters thereof such as cloransulam-methyl;
the imidazolinone herbicides, in particular imazamox, imazapic, imazapyr, and imazethapyr, and the salts and esters thereof;
the sulfonylurea herbicdes, in particular chlorimuron and its esters such as chlorimuron-ethyl.

Examples of herbicides of group (vi) are
anilides such as propanil, pentanochlor or chloranocryl (dicryl);
arylurea herbicides, e.g. chlorbromuron, chlorotoluron, chloroxuron, dimefuron, diuron, ethidimuron, fenuron, fluometuron, isoproturon, isouron, linuron, methabenzthiazuron, metobenzuron, metobromuron, metoxuron, monolinuron, neburon, siduron, tetrafluron, tebuthiuron, thiadiazuron and their salts and esters. Preferred arylurea herbicides herbicides chlortoluron, diuron, linuron, isoproturon and tebuthiuron;
triazin(di)one herbicides (i.e. triazinone and triazindione herbicides), such as ametridione, amibuzin, ethiozin, hexazinone, isomethiozin, metamitron, metribuzin, trifludimoxazin and their salts and esters. Preferred triazin(di)one herbicides include hexazinone, metamitron and metribuzin, in particular metribuzin;
triazine herbicides, e.g. ametryn, atrazine, aziprotryne, chlorazine, cyanatryn, cyanazine, cyprazine, desmetryn, dimethametryn, eglinazine, ipazine, mesoprazine, methoprotryne, prometryn, procyazine, proglinazine, prometon, propazine, sebuthylazine, simazine, simetryn, terbumeton, terbuthylazine, terbutryn, trietazine and their salts and esters, such as eglinazine-ethyl and proglinazine-ethyl. Preferred triazine herbicides include ametryn, atrazine, terbuthylazine and simazine, in particular atrazine;
pyridazinone herbicides, e. g. brompyrazon, chloridazon, dimidazon, metflurazon, norflurazon, oxapyrazon, pydanon and their salts and esters. A preferred pyridazinone herbicide is chloridazon;
phenylcarbamate herbicides, e. g. desmedipham, karbutilate, phenisopham, phenmedipham and their salts and esters, such as phenmedipham-ethyl;
nitrile herbicides, e. g. bromobonil, bromofenoxim, bromoxynil, chloroxynil, dichlobenil, iodobonil and ioxynil and their salts and esters, in particular in case of bromoxynil, chloroxynil and ioxynil. A preferred nitrile herbicide is bromoxynil;
benzothiadiazinone herbicides, e. g. bentazone and its salts, in particular its alkalimetal salts, such as bentazone-sodium;
uracil herbicides, e. g. bromacil, flupropacil, isocil, lenacil, terbacil and the salts of bromacil, in particular its alkalimetal salts, such as bromacil-lithium and bromacil-sodium.

Preferred herbicides of group (vi) are
arylurea herbicides herbicides, in particular chlortoluron, diuron, linuron, isoproturon and tebuthiuron, with particular preference given to diuron;
triazine herbicides, in particular ametryn, atrazine, terbuthylazine and simazine, with particular preference given to atrazine;
anilides, in particular propanil;
bentazone and its salts, in particular its alkalimetal salts, such as bentazone-sodium.

Examples of herbicides of group (vii) are
cyclopropylisoxazole herbicides, such as isoxachlortole and isoxaflutole;
benzoylcyclohexanedione herbicides, such as fenquinotrione, ketospiradox, mesotrione, sulcotrione, tefuryltrione and tembotrione;
benzoylpyrazole herbicides, such as benzofenap, pyrasulfotole, pyrazolynate, pyrazoxyfen, tolpyralate and topramezone;
as well as unclassified herbicides, such as benzobicyclon and bicyclopyrone.

Preferred herbicides of group (vii) are
benzoylcyclohexanedione herbicides, in particular mesotrione and tembotrione,
benzoylpyrazole herbicides, in particular topramezone.

Examples of herbicides of group (viii) are
aryloxyphenoxy-propionate herbicides, e.g. chlorazifop, clodinafop, clofop, cyhalofop, diclofop, fenoxaprop, fenthiaprop, fluazifop, haloxyfop, isoxapyrifop, kuicaoxi, metamifop, propaquizafop, quizalofop, trifop and their enantiomers, salts and esters, such as fenoxaprop-P, fluazifop-P, haloxyfop-P, quizalofop-P, haloxyfop-sodium, chlorazifop-propargyl, clodinafop-propargyl, clofop-isobutyl, cyhalofop-butyl, diclofop-methyl, fenoxaprop-ethyl, fenoxaprop-P-ethyl, fenthiaprop-ethyl, fluazifop-methyl, fluazifop-butyl, fluazifop-P-butyl, haloxyfop-etotyl, haloxyfop-methyl, haloxyfop-P-etotyl, haloxyfop-P-methyl, quizalofop-ethyl, quizalofop-tefuryl, quizalofop-P-ethyl and quizalofop-P-tefuryl;
cyclohexanedione herbicides, e.g. alloxydim, butroxydim, clethodim, cloproxydim, cycloxydim, profoxydim, sethoxydim, tepraloxydim, tralkoxydim and their salts, such as alloxydim-sodium; and
phenylpyrazoline herbicides, such as pinoxaden.

Preferred herbicides of group (viii) are clethodim, quizalofop and pinoxaden.

Suitable salts of the aforementioned organic herbicide compounds, in particular those having a carboxyl group are the salts of those cations which have no adverse effect on the action of the herbicide active compounds (“agricultural acceptable”). Preferred cations are the ions of the alkali metals, preferably of lithium, sodium and potassium, of the alkaline earth metals, preferably of calcium and magnesium, and of the transition metals, preferably of manganese, copper, zinc and iron, furthermore ammonium and substituted ammonium (hereinafter also termed as organoammonium) in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, tetramethylammonium, tetraethylammonium, tetrabutylammonium, pentylammonium, hexylammonium, heptylammonium, 2-hydroxyethylammonium, 2-(2-hydroxyethoxy)eth-1-ylammonium, (diglycolamine salts), di(2-hydroxyeth-1-yl)ammonium (diolamine salts), tris((2-hydroxyeth-1-yl)ammonium (trolamine salts), tris(3-propanol)amonium, benzyltrimethylammonium, benzyltriethylammonium, furthermore phosphonium ions, sulfonium ions, preferably tri(C₁-C₄-alkyl)sulfonium such as trimethylsulfonium, and sulfoxonium ions, preferably tri(C₁-C₄-alkyl)sulfoxonium.

In the method and use of the invention, the organic herbicide compounds having a carboxyl group may also be present in the form of their derivatives, for example as amides such as mono- or di-C₁-C₆-alkylamides or arylamides, as esters, for example as allyl esters, propargyl esters, C₁-C₁₀-alkyl esters or alkoxyalkyl esters, and also as thioesters, for example as C₁-C₁₀-alkyl thioesters. Preferred mono- and di-C₁-C₆-alkylamides are the methyl- and the dimethylamides. Preferred arylamides are, for example, the anilidines and the 2-chloroanilides. Preferred alkyl esters are, for example, the methyl, ethyl, propyl, isopropyl, butyl, isobutyl, pentyl, mexyl (1-methylhexyl) or isooctyl (2-ethylhexyl) esters. Preferred C₁-C₄-alkoxy-C₁-C₄-alkyl esters are the straight-chain or branched C₁-C₄-alkoxyethyl esters, for example the methoxyethyl, ethoxyethyl or butoxyethyl esters. An example of the straight-chain or branched C₁-C₁₀-alkyl thioesters is the ethyl thioester. Preferred derivatives are the esters.

In particular, the herbicide compound for the use, the method and for the aqueous composition of the invention comprises least one organic herbicide compound, which is selected from the group consisting of glufosinate, bialaphos, glyphosate, dicamba, chloramben, 2,4-D, endothal, mecoprop, picloram, triclopyr, fluroxypyr, 2,4,5-T, MCPA, MCPB, dichlorprop, dichlorprop P, imazamox, imazapyr, imazapic, imazethapyr, imazaquin, cloransulam, chlorimuron, acifluorfen, saflufenacil, fomesafen, atrazine, propanil, bentazon, diuron, quizalofop, clethodim, pinoxaden, topramezone, mesotrione, the salts thereof, the esters thereof and combinations thereof.

Especially, the herbicide compound for the use, for the method and for the aqueous composition of the invention comprises at least one organic herbicide compound, which is selected from the group consisting of glufosinate, glyphosate and dicamba, the salts thereof, the esters thereof and combinations thereof, optionally in combination with at least one of the aforementioned herbicide compounds which are different therefrom.

In a particular group of embodiments, the herbicide comprises an organic herbicide compound that has at least one carboxyl group or a salt thereof. Suitable organic herbicide compounds which have at least one carboxyl group include glufosinate, glyphosate, bialaphos, dicamba, acifluorfen, chloramben, 2,4-D, endothal, mecoprop, picloram, 2,4,5-T, benzac, MCPA, MCPB, dichlorprop, dichlorprop P, dalapon, triclopyr, fluroxypyr, imazamox, imazapyr, imazapic, imazethapyr, imazaquin, fomesafen, acifluorfen and combinations thereof. The aforementioned compounds may be used in the form of their carboxylic acids or their salts or in the form of their derivatives, i.e. as their amides or esters. Preferably, the herbicides having a carboxyl group are present in the form of their salts.

According to a particular preferred group (4) of embodiments, the herbicide comprises glufosinate or a salt thereof.

Glufosinate (CAS Reg. No. 51276-47-2; IUPAC-Name (2RS)-2-amino-4-[hydroxy(methyl)-phosphinoyl]butyric acid, or 4-[hydroxy(methyl)phosphinoyl]-DL-homoalanine or DL-4-[hydroxyl(methyl)phosphinoyl]-DL-homoalaninate), is known, as well as agronomically acceptable salts thereof, such as glufosinate-sodium, glufosinate potassium and in particular glufosinate-ammonium (IUPAC-Name: ammonium (2RS)-2-amino-4-(methylphosphinato)-butyric acid, CAS Reg. No. 77182-82-2). U.S. Pat. No. 4,168,963 describes phosphorus-containing compounds with herbicidal activity, of which, in particular, phosphinothricin (2-amino-4-[hydroxy(methyl)phosphinoyl]butanoic acid; common name: glufosinate) and its salts have acquired commercial importance in the agrochemistry (agricultural chemistry) sector. For example, glufosinate and its salts—such as glufosinate ammonium—and its herbicidal activity have been described e.g. by F. Schwerdtle et al. Z. Pflanzenkr. Pflanzenschutz, 1981, Sonderheft IX, pp. 431-440. Glufosinate as racemate and its salts are commercially available under the trade-names Basta™ and Liberty™. Glufosinate is represented by the following structure (IV):

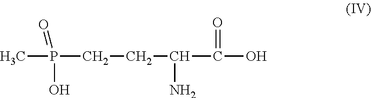

The compound of formula (IV) is a racemate. Glufosinate is a racemate of two enantiomers, out of which only one shows sufficient herbicidal activity (see e.g. U.S. Pat. No. 4,265,654 and JP92448/83). Even though various methods to prepare L-glufosinate (and respective salts) are known, the mixtures known in the art do not point at the stereochemistry, meaning that the racemate is present (e.g. WO 2003024221, WO 2011104213, WO 2016113334, WO 2009141367).

In one embodiment, the herbicidal composition comprises racemic glufosinate mixtures as described above, wherein the glufosinate comprises about 50% by weight of the L-enantiomer and about 50% by weight of the D-enantiomer. In another embodiment, the herbicidal composition comprises glufosinate, wherein at least 70% by weight of the glufosinate is L-glufosinate or a salt thereof.

L-glufosinate, with IUPAC-Name (2S)-2-amino-4-[hydroxy(methyl)phosphinoyl]butyric acid (CAS Reg. No. 35597-44-5) and also called glufosinate-P, can be obtained commercially or may be prepared for example as described in WO2006/104120, U.S. Pat. No. 5,530,142, EP0248357A2, EP0249188A2, EP0344683A2, EP0367145A2, EP0477902A2, EP0127429 and J. Chem. Soc. Perkin Trans. 1, 1992, 1525-1529. Preferably, the salts of glufosinate or (L)-glufosinate are the sodium, potassium or ammonium (NH₄⁺) salts of glufosinate or L-glufosinate, in particular glufosinate-P-ammonium (IUPAC-Name: ammonium (2S)-2-amino-4-(methyl-phosphinato)butyric acid, CAS Reg. No. 73777-50-1), glufosinate-P-sodium (IUPAC-Name: sodium (2S)-2-amino-4-(methylphosphinato)butyric acid; CAS Reg. No. 70033-13-5) and glufosinate-P-potassium (IUPAC-Name: potassium (2S)-2-amino-4-(methylphosphinato)butyric acid) for L-glufosinate. Hence, mixtures may contain (L)-glufosinate-ammonium or (L)-glufosinate-sodium or (L)-glufosinate-potassium as (L)-glufosinate salts and (L)-glufosinate as free acid, preferably (L)-glufosinate. Especially preferred are herbicidal compositions, which contain (L)-glufosinate-ammonium, i.e. the ammonium (NH₄⁺) salt of glufosinate. The term “glufosinate” as used in the present invention typically comprises, in one embodiment of the invention, about 50% by weight of the L-enantiomer and about 50% by weight of the D-enantiomer; and in another embodiment of the invention, more than 70% by weight of the L-enantiomer; preferably more than 80% by weight of the L-enantiomer; more preferably more than 90% of the L-enantiomer, most preferably more than 95% of the L-enantiomer and can be prepared as referred to above.

According to another particular group (5) of embodiments, the herbicide comprises glyphosate or a salt thereof as the herbicide active compounds.

Suitable salts of glyphosate are for example glyphosate-ammonium, glyphosate-diammonium, glyphosate-dimethylammonium, glyphosate-isopropylammonium, glyphosate-potassium, glyphosate-sodium, glyphosate-trimesium as well as the ethanolamine and diethanolamine salts, preferably glyphosate-diammonium, glyphosate-isopropylammonium and glyphosate-trimesium (sulfosate).

According to another particular group (6) of embodiments, the herbicide comprises a herbicide of group (iii), which is in particular selected from the group consisting of benzoic acid herbicides, in particular dicamba and its salts, the phenoxy herbicides, in particular 2,4-D and its salts, and the quinolone carboxylic acids, in particular quinclorac and the salts thereof.

According to particular preferred group (6a) of embodiments, the herbicide comprises dicamba or a salt thereof. Suitable salts of dicamba are dicamba-sodium, dicamba-potassium, dicamba-methylammonium, dicamba-dimethylammonium, dicamba-isopropylammonium, dicamba-diglycolamine, dicamba-olamine, dicamba-diolamine, dicamba-trolamine, dicamba-N,N-bis-(3-aminopropyl)methylamine and dicamba-diethylenetriamine. Examples of a suitable ester are dicamba-methyl and dicamba-butotyl.

According to another particular group (7) of embodiments, the herbicide comprises a herbicide of the group of PPO inhibitors, which is in particular selected from the group consisting of flumioxazin, carfentrazone, sulfentrazone, butafenacil, acifluorfen, fomesafen, lactofen, oxyfluorfen, saflufenacil and trifludimoxazin, and their agriculturally acceptable salts and esters, such as in particular fomesafen-sodium, acifluorfen-sodium, acifluorfen-methyl, carfentrazone-ethyl. In group (7), particular preference is given to the group of PPO inhibitors selected from saflufenacil, fomesafen or a salt thereof, such as fomesafen sodium, and flumioxazin.

According to another particular group (8) of embodiments, the herbicide comprises a herbicide of the group of ALS inhibitors, which is in particular selected from the group consisting of
the triazolopyrimidine herbicides, in particular cloransulam, and the salts and esters thereof such as cloransulam-methyl;
the imidazolinone herbicides, in particular imazamox, imazapic, imazapyr, and imazethapyr, and the salts and esters thereof;
the sulfonylurea herbicdes, in particular chlorimuron and its esters such as chlorimuron-ethyl.

According to another particular preferred group (8a) of embodiments, the herbicide comprises an imidazolinone or a salt thereof as the herbicide active compounds, in particular an imidazolinone selected from the group consisting of imazapic, imazamox, imazapyr, imazaquin, imazethapyr or a combination thereof, or a salt or combination of salts thereof.

Suitable salts of the imidazolinone herbicides are imazapic salts, imazamox salts, imazapyr salts, imazaquin salts, imazethapyr salts. A suitable salt of imazamox is for example imazamox-ammonium. Suitable salts of imazapic are for example imazapic-ammonium and imazapic-isopropylammonium. Suitable salts of imazapyr are for example imazapyr-ammonium and imazapyr-isopropylammonium. A suitable salt of imazaquin is for example imazaquin-ammonium. Suitable salts of imazethapyr are for example imazethapyr-ammonium and imazethapyr-isopropylammonium.

According to another particular group (9) of embodiments, the herbicide comprises a herbicide of the group of PSII inhibitors, which is in particular selected from the group consisting of
arylurea herbicides herbicides, in particular chlortoluron, diuron, linuron, isoproturon and tebuthiuron, with particular preference given to diuron;
triazine herbicides, in particular ametryn, atrazine, terbuthylazine and simazine, with particular preference given to atrazine;
anilides, in particular propanil;
bentazone and its salts, in particular its alkalimetal salts, such as bentazone-sodium.

In the particular group (9) of embodiments, the herbicide comprises especially a herbicide compound, which is selected from diuron, atrazine, propanil and benazone or a salt thereof, such as bentazone sodium.

According to another particular group (10) of embodiments, the herbicide comprises a herbicide of the group of HPPD inhibitors, which is in particular selected from the group consisting of
benzoylcyclohexanedione herbicides, in particular mesotrione and tembotrione,
benzoylpyrazole herbicides, in particular topramezone.

According to another particular group (11) of embodiments, the herbicide comprises a herbicide of the group of HPPD inhibitors, which is in particular selected from the group consisting of clethodim, quizalofop and pinoxaden.

Generally, the copolymers CP are included in the spray liquor together with a suitable formulation of the herbicide active ingredient. Generally, the formulation containing the herbicide active ingredient is a formulation which can be easily diluted with water. Suitable formulations of herbicide active ingredients include, but are not limited to water-soluble concentrates (SL or LS formulations), dispersible concentrates (DC formulations), emulsifiable concentrates (EC formulations), emulsions (EW, EO or ES formulations), suspension concentrates which may be water-based or oil-based (SC, OD or FS formulations), microemulsions (ME formulations), microcapsule formulations (CS formulations), wettable powders or dusts (e.g., WP, SP, WS, DP, DS), wettable granules (e.g., WG, SG, GR, FG, GG, MG) and the like. These and further composition types are defined in the “Catalogue of pesticide formulation types and international coding system”, Technical Monograph No. 2, 6th Ed. May 2008, CropLife International.

Besides the herbicide active ingredient, the formulation thereof may contain one or more of conventional formulation auxiliaries, including solvents, liquid carriers, solid carriers or fillers, surfactants, dispersants, emulsifiers, wetters, adjuvants, solubilizers, penetration enhancers, protective colloids, adhesion agents, thickeners, humectants, anti-freezing agents, anti-foaming agents, colorants, crystal growth inhibitors, tackifiers and binders. Obviously, these ingredients will be present in the aqueous spray liquor. The concentration of the herbicide active ingredient in the formulation may vary and is typically in the range of 50 to 800 g/kg of the formulation.

Suitable solvents and liquid carriers are water and organic solvents, such as mineral oil fractions of medium to high boiling point, e.g., kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g., ethanol, propanol, butanol, benzylalcohol, cyclohexanol; glycols; DMSO; ketones, e.g., cyclohexanone; esters, e.g., lactates, carbonates, fatty acid esters, gamma-butyrolactone; fatty acids; phosphonates; amines; amides, e.g., N-methylpyrrolidone, fatty acid dimethylamides; and mixtures thereof.

Suitable solid carriers or fillers are mineral earths, e.g., silicates, silica gels, talc, kaolins, limestone, lime, chalk, clays, dolomite, diatomaceous earth, bentonite, calcium sulfate, magnesium sulfate, magnesium oxide; polysaccharides, e.g., cellulose, starch; fertilizers, e.g., ammonium sulfate, ammonium phosphate, ammonium nitrate, ureas; products of vegetable origin, e.g., cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable thickeners are polysaccharides (e.g., xanthan gum, carboxymethylcellulose), inorganic clays (organically modified or unmodified), polycarboxylates, and silicates. Suitable bactericides are bronopol and isothiazolinone derivatives such as alkylisothiazolinones and benzisothiazolinones. Suitable anti-freezing agents are ethylene glycol, propylene glycol, urea and glycerin. Suitable anti-foaming agents are silicones, long chain alcohols, and salts of fatty acids. Suitable colorants (e.g., in red, blue, or green) are pigments of low water solubility and water-soluble dyes. Examples are inorganic colorants (e.g., iron oxide, titan oxide, iron hexacyanoferrate) and organic colorants (e.g., alizarin-, azo- and phthalocyanine colorants). Suitable tackifiers or binders are polyvinylpyrrolidons, polyvinylacetates, polyvinyl alcohols, polyacrylates, biological or synthetic waxes, and cellulose ethers.

In addition to water, the copolymer CP and the herbicide (including the herbicide active ingredient and optionally formulation auxiliaries), the aqueous spray liquor may contain one or more further agriculturally active ingredients. Further agriculturally active ingredients may be selected from fungicides, insecticides, nematicides, safeners, fertilizers, micronutrients, biopesticides, nitrification inhibitors, urease inhibitors, and/or growth regulators. Combinations of herbicides and safeners may be particularly useful. Suitable safeners include (quinolin-8-oxy)acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenylcarbamates and their agriculturally acceptable salts and their agriculturally acceptable derivatives such amides, esters, and thioesters, provided they have an acid group.

In a preferred group (8) of embodiments, the aqueous spray liquor contains at least one inorganic compound, in particular at least one inorganic salt or a salt of a carboxylic acid. The salt of the carboxylic acid itself has no noticeable herbicidal activity. Typical carboxylic acids are alkanoic acids having 1 to 6 carbon atoms. Preferably, the salt is water-soluble, i. e. its solubility in deionized water at 25° C. is at least 10 g/L. In particular, the salt is completely dissolved in the aqueous spray liquor.

The aqueous compound is in particular a salt which qualifies as a fertilizer, e.g. a potassium salt, a magnesium salt or an ammonium salt such as potassium chloride, potassium sulfate, magnesium sulfate, ammonium sulfate or a combination thereof. In particular the inorganic compound is an ammonium salt, especially ammonium sulfate or ammonium acetate.

In the preferred group (8) of embodiments, the herbicide preferably comprises an organic herbicide compound bearing a carboxyl group as described above or a salt thereof, in particular glufosinate or a salt thereof, dicamba or a salt thereof or glyphosate or a salt thereof.

The aqueous spray liquor containing the herbicide and the copolymer CP is used for controlling undesired vegetation on crop area and on non-crop areas.

The aqueous spray liquor allows for very efficient control of undesired vegetation on non-crop area and in crops. On non-crop area very efficient control is achieved at high application rates. Depending on the herbicide active compound, application of the spray liquor allows for efficient control of broad-leafed weeds and grass weeds in crops such as wheat, rice, corn, soybeans and cotton without causing any significant damage to the crop plants. This effect is mainly observed at low rates of application.

The spray liquor is generally applied to the undesired plants mainly by spraying the leaves. Here, the application can be carried out by customary spraying techniques using spray liquor amounts of from about 100 to 1000 I/ha. Application of the spray liquor can be done before, during and/or after, preferably during and/or after, the emergence of the undesirable plants. When employed in plant protection, the amounts of glufosinate or salt thereof without formulation auxiliaries, are, depending on the kind of effect desired, from 0.001 to 2 kg per ha, preferably from 0.005 to 2 kg per ha, more preferably from 0.05 to 0.9 kg per ha and in particular from 0.1 to 0.75 kg per ha.

Examples of suitable crops are the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N.rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

The aqueous spray liquor can also be used in crops which have been modified by mutagenesis or genetic engineering in order to provide a new trait to a plant or to modify an already present trait, preferably a resistance against glufosinate or its salts.

The term “crops” as used herein includes also (crop) plants which have been modified by mutagenesis or genetic engineering in order to provide a new trait to a plant or to modify an already present trait. Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPRJCas, zinc-finger nucleases, TALENs or meganucleases to achieve the targeting effect. Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transformation usually produces several transformation events, which differ in the genomic locus in which a transgene has been integrated. Plants comprising a specific transgene on a specific genomic locus are usually described as comprising a specific “event”, which is referred to by a specific event name. Traits which have been introduced in plants or have been modified include in particular herbicide tolerance, insect resistance, increased yield and tolerance to abiotic conditions, like drought.

Herbicide tolerance has been created by using mutagenesis as well as using genetic engineering. Plants which have been rendered tolerant to acetolactate synthase (ALS) inhibitor herbicides by conventional methods of mutagenesis and breeding comprise plant varieties commercially available under the name Clearfield®. However, most of the herbicide tolerance traits have been created via the use of transgenes.

Herbicide tolerance has been created to glyphosate, glufosinate, 2,4-D, dicamba, oxynil herbicides, like bromoxynil and ioxynil, sulfonylurea herbicides, ALS inhibitor herbicides and 4-hydroxyphenylpyruvate dioxygenase (HPPD) inhibitors, like isoxaflutole and mesotrione.

Transgenes which have been used to provide herbicide tolerance traits comprise: for tolerance to glyphosate: cp4 epsps, epsps grg23ace5, mepsps, 2mepsps, gat4601, gat4621 and goxv247, for tolerance to glufosinate: pat and bar, for tolerance to 2,4-D: aad-1 and aad-12, for tolerance to dicamba: dmo, for tolerance to oxynil herbicies: bxn, for tolerance to sulfonylurea herbicides: zm-hra, csr1-2, μm-hra, S4-HrA, for tolerance to ALS inhibitor herbicides: csr1-2, for tolerance to HPPD inhibitor herbicides: hppdPF, W336 and avhppd-03.

Transgenic corn events comprising herbicide tolerance genes are for example, but not excluding others, DAS40278, MON801, MON802, MON809, MON810, MON832, MON87411, MON87419, MON87427, MON88017, MON89034, NK603, GA21, MZHGOJG, HCEM485, VCO-01981-5, 676, 678, 680, 33121, 4114, 59122, 98140, Bt10, Bt176, CBH-351, DBT418, DLL25, MS3, MS6, MZIR098, T25, TC1507 and TC6275.

Transgenic soybean events comprising herbicide tolerance genes are for example, but not excluding others, GTS 40-3-2, MON87705, MON87708, MON87712, MON87769, MON89788, A2704-12, A2704-21, A5547-127, A5547-35, DP356043, DAS44406-6, DAS68416-4, DAS-81419-2, GU262, SYHTØH2, W62, W98, FG72 and CV127.

Transgenic cotton events comprising herbicide tolerance genes are for example, but not excluding others, 19-51a, 31707, 42317, 81910, 281-24-236, 3006-210-23, BXN10211, BXN10215, BXN10222, BXN10224, MON1445, MON1698, MON88701, MON88913, GHB119, GHB614, LLCotton25, T303-3 and T304-40.

Transgenic canola events comprising herbicide tolerance genes are for example, but not excluding others, MON88302, HCR-1, HCN10, HCN28, HCN92, MS1, MS8, PHY14, PHY23, PHY35, PHY36, RF1, RF2 and RF3.

Insect resistance has mainly been created by transferring bacterial genes for insecticidal proteins to plants. Transgenes which have most frequently been used are toxin genes of Bacillus spec. and synthetic variants thereof, like cry1A, cry1Ab, cry1Ab-Ac, cry1Ac, cry1A.105, cry1F, cry1Fa2, cry2Ab2, cry2Ae, mcry3A, ecry3.1Ab, cry3Bb1, cry34Ab1, cry35Ab1, cry9C, vip3A(a), vip3Aa20. However, also genes of plant origin have been transferred to other plants. In particular genes coding for protease inhibitors, like CpTI and pinII. A further approach uses transgenes in order to produce double stranded RNA in plants to target and downregulate insect genes. An example for such a transgene is dvsnf7.

Transgenic corn events comprising genes for insecticidal proteins or double stranded RNA are for example, but not excluding others, Bt10, Bt11, Bt176, MON801, MON802, MON809, MON810, MON863, MON87411, MON88017, MON89034, 33121, 4114, 5307, 59122, TC1507, TC6275, CBH-351, MIR162, DBT418 and MZIR098.

Transgenic soybean events comprising genes for insecticidal proteins are for example, but not excluding others, MON87701, MON87751 and DAS-81419.

Transgenic cotton events comprising genes for insecticidal proteins are for example, but not excluding others, SGK321, MON531, MON757, MON1076, MON15985, 31707, 31803, 31807, 31808, 42317, BNLA-601, Event1, COT67B, COT102, T303-3, T304-40, GFM Cry1A, GK12, MLS 9124, 281-24-236, 3006-210-23, GHB119 and SGK321.

Increased yield has been created by increasing ear biomass using the transgene athb17, being present in corn event MON87403, or by enhancing photosynthesis using the transgene bbx32, being present in the soybean event MON87712.

Crops comprising a modified oil content have been created by using the transgenes: gm-fad2-1, Pj.D6D, Nc.Fad3, fad2-1A and fatb1-A. Soybean events comprising at least one of these genes are: 260-05, MON87705 and MON87769.

Tolerance to abiotic conditions, in particular to tolerance to drought, has been created by using the transgene cspB, comprised by the corn event MON87460 and by using the transgene Hahb-4, comprised by soybean event IND-00410-5.

Traits are frequently combined by combining genes in a transformation event or by combining different events during the breeding process. Preferred combination of traits are herbicide tolerance to different groups of herbicides, insect tolerance to different kind of insects, in particular tolerance to lepidopteran and coleopteran insects, herbicide tolerance with one or several types of insect resistance, herbicide tolerance with increased yield as well as a combination of herbicide tolerance and tolerance to abiotic conditions.

Plants comprising singular or stacked traits as well as the genes and events providing these traits are well known in the art. For example, detailed information as to the mutagenized or integrated genes and the respective events are available from websites of the organizations “International Service for the Acquisition of Agri-biotech Applications (ISAAA)” (http://www.isaaa.org/gmapprovaldatabase) and the “Center for Environmental Risk Assessment (CERA)” (http://cera-gmc.org/GMCropDatabase), as well as in patent applications, like EP3028573 and WO2017/011288.

The use the spray liquors according to the invention on crops may result in effects which are specific to a crop comprising a certain gene or event. These effects might involve changes in growth behavior or changed resistance to biotic or abiotic stress factors. Such effects may in particular comprise enhanced yield, enhanced resistance or tolerance to insects, nematodes, fungal, bacterial, Mycoplasma, viral or viroid pathogens as well as early vigour, early or delayed ripening, cold or heat tolerance as well as changed amino acid or fatty acid spectrum or content.

Furthermore, plants are also covered that contain by the use of recombinant DNA techniques a modified amount of ingredients or new ingredients, specifically to improve raw material production, e.g., potatoes that produce increased amounts of amylopectin (e.g. Amflora® potato, BASF SE, Germany).

Furthermore, it has been found that the herbicidal compositions according to the invention are also suitable for the defoliation and/or desiccation of plant parts, for which crop plants such as cotton, potato, oilseed rape, sunflower, soybean or field beans, in particular cotton, are suitable. In this regard, herbicidal compositions have been found for the desiccation and/or defoliation of plants, processes for preparing these compositions, and methods for desiccating and/or defoliating plants using the herbicidal compositions according to the invention.

As desiccants, herbicidal compositions according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton.

Moreover, a shortening of the time interval in which the individual cotton plants mature leads to an increased fiber quality after harvesting.

The aqueous spray liquor may be applied in or on permanent cropland, or on permanent crops. A permanent crop is one produced from plants which last for many seasons, rather than being re-planted after each harvest. Permanent crops are grown on permanent crop land in the form of agricultural land that includes grasslands and shrublands, e.g. used to grow grape vines or coffee; orchards used to grow fruit or olives; and forested plantations, e.g. used to grow nuts or rubber. It does not include, however, tree farms intended to be used for wood or timber.

Preferred permanent croplands in the context of the present invention are plantations, grasslands and shrublands. Preferably, the permanent crops in the context of the present invention are plantation crops, and preferably are selected from the group consisting fruit crops and orchard crops (preferably fruit trees, citrus trees, mango trees, olive trees, grape vines, coffee, cocoa, tea, and berries (such as strawberries, raspberries, blueberries and currants)), Musaceae sp. crops (for example banana or plantain crops), nut trees (preferably almond trees, walnut trees, pistachio trees, pecan trees, hazelnut trees), oil palm trees, rubber trees, sugarcane and cotton.

More preferably, the permanent crops are fruit trees (preferably pome fruit trees and stone fruit trees; preferred fruit trees are apple trees, pear trees, apricot trees, plum trees, cherry trees, peach trees), olive trees, grape vines, coffee, tea), Musaceae sp. crops (preferably banana crops or plantain crops), nut trees (preferably almond trees, walnut trees, pistachio trees, pecan trees, hazelnut trees), oil palm trees, rubber trees, and citrus crops (preferably lemon, orange or grapefruit crops). Even more preferably, the permanent crops are selected from the group consisting of apple trees, pear trees, apricot trees, plum trees, cherry trees, peach trees, olive trees, grape vines, coffee, tea, banana crops, nut trees (preferably almond trees, walnut trees, pistachio trees), oil palm trees, rubber trees, and citrus crops (preferably lemon, orange or grapefruit crops). Particularly preferably, the permanent crops are selected from the group consisting of apple trees, pear trees, apricot trees, plum trees, cherry trees, peach trees, olive trees, grape vines, coffee, tea, banana crops, almond trees, walnut trees, oil palm trees, rubber trees, lemon crops, orange crops and grapefruit crops.

The herbicidal composition may also be applied on row crops and as well on specialty crops.

Row crops can be planted in rows wide enough to allow it to be tilled or otherwise cultivated by agricultural machinery, machinery tailored for the seasonal activities of row crops. The particularity of row crops is that they are planted and cultivated on a seasonal or yearly basis. Therefore, such crops yield products and profit relatively quickly and predictably. A row crop is one produced from plants which last for many seasons, rather than being re-planted after each harvest. Examples of row crops include soybeans, corn, canola, cotton, cereals or rice, but as well sunflower, potato, dry bean, field pea, flax, safflower, buckwheat and sugar beets.

Specialty crops are to be understood as fruits, vegetables or other specialty or plantation permanent crops such as trees, nuts, vines, (dried) fruits, ornamentals, oil palm, banana, rubber and the like, Horticulture and nursery crops, including floriculture, may also fall under the definition of specialty crops. Vegetable crops includes for example aubergine, beans, bell pepper, cabbage, chili, cucumber, eggplant, lettuce, melon, onion, potato, sweet potato, spinach and tomato. Plants being considered specialty crops are in general intensively cultivated. For weed control in vegetable crops, it may be desirable to shield the crops from contact with the spray solution that contains the herbicidal mixture according to the present invention.

In general, the crops which may be treated with the aqueous spray liquor, may be of conventional origin or may be herbicide tolerant crops, preferably crops, which are tolerant at least against one of glufosinate, glyphosate and/or dicamba. The herbicidal composition shows high herbicidal effects also against select crop plants, such as barley and soybean. This effect can be used to control crop plants in crop rotation methods of previously grown crop cultures. Typically, residual crop plants from previous rotation cycles remain after harvest and continue to grow within the subsequently grown crop variety. This reduces the yield since the crop plants of two different crop rotation cycles compete on the same locus of growth. The herbicidal composition may thus be applied to control residual crop plants from previous crop rotation cycles to allow for a homogeneous coverage with the subsequent crop plant.

In a preferred embodiment, the herbicidal composition is applied once, twice or three times per Gregorian calendar year, i.e. in one application, in two applications or in three applications per year according to the Gregorian calendar. In a preferred embodiment, the herbicidal composition is applied twice per Gregorian calendar year, i.e. in two applications per year according to the Gregorian calendar. In an alternatively preferred embodiment, the herbicidal composition is applied one time per Gregorian calendar year, i.e. in one application per year according to the Gregorian calendar. In a preferred embodiment, the herbicidal composition is applied one time in about 12 months, i.e. in one application in about 12 months. In an alternative preferred embodiment, the herbicidal composition is applied between one and ten times per Gregorian calendar year, i.e. in up to ten applications per year according to the Gregorian calendar. This alternative preferred method is of particular usefulness in permanent crops, in particular those grown under tropical conditions; in which case weeds grow vigorously at any time of the year, and herbicide applications are to be repeated as soon as the previous treatment loses its effectiveness and weeds start to regrow.

In a particular group 8 of embodiments, the herbicidal compositions are preferably used in post-emergence applications.

The invention includes the use and methods of application of the aqueous spray liquor for controlling undesirable vegetation in crops in a burndown program, wherein the crop is produced by genetic engineering or by breeding, are tolerant to one or more herbicides and/or resistant to pathogens such as plant-pathogenous fungi, and/or to attack by insects; preferably tolerant to glufosinate.

Preferred are crops, which are tolerant to glufosinate, wherein the glufosinate tolerant crop plant is preferably selected from the group consisting of rice, canola, soybean, corn and cotton plants.

Transgenic corn events comprising glufosinate tolerance genes are for example, but not excluding others, 5307 x MIR604 x Bt11 x TC1507 x GA21 x MIR162 (event code: SYN-Ø53Ø7-1 x SYN-IR6Ø4-5 x SYN-BTØ11-1 x DAS-Ø15Ø7-1 x MON-ØØØ21-9 x SYN-IR162-4, gene: pat, e.g. commercially available as Agrisure® Duracade™ 5222), 59122 (event code: DAS-59122-7, gene: pat, e.g. commercially available as Herculex™ RW), 5307 x MIR604 x Bt11 x TC1507 x GA21 (event code: SYN-Ø53Ø7-1 x SYN-IR6Ø4-5 x SYN-BTØ11-1 x DAS-Ø15Ø7-1 x MON-ØØØ21-9, gene: pat, e.g. commercially available as Agrisure® Duracade™ 5122), 59122 x NK603 (event code: DAS-59122-7 x MON-ØØ6Ø3-6, gene: pat, e.g. commercially available as Herculex™ RW Roundup Ready™ 2), Bt10 (gene: pat, e.g. commercially available as Bt10), Bt11 (X4334CBR, X4734CBR) (event code: SYN-BTØ11-1, gene: pat, e.g. commercially available as Agrisure™ CB/LL), BT11 x 59122 x MIR604 x TC1507 x GA21 (event code: SYN-BTØ11-1 x DAS-59122-7 x SYN-IR6Ø4-5 x DAS-Ø15Ø7-1 x MON-ØØØ21-9, gene: pat, e.g. commercially available as Agrisure® 3122), Bt11 x GA21 (event code: SYN-BTØ11-1 x MON-ØØØ21-9, gene: pat, e.g. commercially available as Agrisure™ GT/CB/LL), Bt11 x MIR162 (event code: SYN-BTØ11-1 x SYN-IR162-4, gene: pat, e.g. commercially available as Agrisure® Viptera™ 2100), Bt11 x MIR162 x GA21 (event code: SYN-BTØ11-1 x SYN-IR162-4 x MON-ØØØ21-9, gene: pat, e.g. commercially available as Agrisure®Viptera™ 3110), BT11 x MIR162 x MIR604 (event code: SYN-BTØ11-1 x SYN-IR162-4 x SYN-IR6Ø4-5, gene: pat, e.g. commercially available as Agrisure® Viptera™ 3100), Bt11 x MIR162 x MIR604 x GA21 (event code: SYN-BTØ11-1 x SYN-IR162-4 x SYN-IR6Ø4-5 x MON-ØØØ21-9, gene: pat, e.g. commercially available as Agrisure® Viptera™ 3111, Agrisure® Viptera™ 4), Bt11 x MIR162 x TC1507 x GA21 (event code: SYN-BTØ11-1 x SYN-IR162-4 x DAS-Ø15Ø7-1 x MON-ØØØ21-9, gene: pat, e.g. commercially available as Agrisure™ Viptera 3220), Bt11 x MIR604 (event code: SYN-BTØ11-1 x SYN-IR6Ø4-5, gene: pat, e.g. commercially available as Agrisure™ CB/LL/RW), BT11 x MIR604 x GA21 (event code: SYN-BTØ11-1 x SYN-IR6Ø4-5 x MON-ØØØ21-9, gene: pat, e.g. commercially available as Agrisure™ 3000GT), Bt176 (176) (event code: SYN-EV176-9, gene: bar, e.g. commercially available as NaturGard KnockOut™, Maximizer™), CBH-351 (event code: ACS-ZM004-3, gene: bar, e.g. commercially available as Starlink™ Maize), DBT418 (event code: DKB-89614-9, gene: bar, e.g. commercially available as Bt Xtra™ Maize), MON89034 x TC1507 x MON88017 x 59122 (event code: MON-89Ø34-3 x DAS-Ø15Ø7-1 x MON-88Ø17-3 x DAS-59122-7, gene: pat, e.g. commercially available as Genuity® SmartStax™), MON89034 x TC1507 x NK603 (event code: MON-89Ø34-3 x DAS-Ø15Ø7-1 x MON-ØØ6Ø3-6, gene: pat, e.g. commercially available as Power Core™), NK603 x T25 (event code: MON-ØØ6Ø3-6 x ACS-ZMØØ3-2, gene: pat, e.g. commercially available as Roundup Ready™ Liberty Link™ Maize), T14 (event code: ACS-ZM002-1, gene: pat, e.g. commercially available as Liberty Link™ Maize), T25 (event code: ACS-ZMØØ3-2, gene: pat, e.g. commercially available as Liberty Link™ Maize), T25 x MON810 (event code: ACS-ZMØØ3-2 x MON-ØØ81Ø-6, gene: pat, e.g. commercially available as Liberty Link™ Yieldgard™ Maize), TC1507 (event code: DAS-Ø15Ø7-1, gene: pat, e.g. commercially available as Herculex™ I, Herculex™ CB), TC1507 x 59122 x MON810 x MIR604 x NK603 (event code: DAS-Ø15Ø7-1 x DAS-59122-7 x MON-ØØ81Ø-6 x SYN-IR6Ø4-5 x MON-ØØ6Ø3, gene: pat, e.g. commercially available asOptimum™ Intrasect Xtreme), TC1507 x 59122 (event code: DAS-Ø15Ø7-1 x DAS-59122-7, gene: pat, e.g. commercially available as Herculex XTRA™), TC1507 x 59122 x MON810 x NK603 (event code: DAS-Ø15Ø7-1 x DAS-59122-7 x MON-ØØ81Ø-6 x MON-ØØ6Ø3-6, gene: pat, e.g. commercially available as Optimum™ Intrasect XTRA), TC1507 x 59122 x NK603 (event code: DAS-Ø15Ø7-1 x DAS-59122-7 x MON-ØØ6Ø3-6, gene: pat, e.g. commercially available as Herculex XTRA™ RR), TC1507 x MIR604 x NK603 (event code: DAS-Ø15Ø7-1 x SYN-IR6Ø4-5 x MON-ØØ6Ø3-6, gene: pat, e.g. commercially available as Optimum™ TRIsect), TC1507 x MON810 x NK603 (event code: DAS-Ø15Ø7-1 x MON-ØØ81Ø-6 x MON-ØØ6Ø3-6, gene: pat, e.g. commercially available as Optimum™ Intrasect), TC1507 x NK603 (event code: DAS-Ø15Ø7-1 x MON-ØØ6Ø3-6, gene: pat, e.g. commercially available as Herculex™ I RR), 3272 x Bt11 (event code: SYN-E3272-5 x SYN-BTØ11-1 gene: pat), 3272 x Bt11 x GA21 (event code: SYN-E3272-5 x SYN-BTØ11-1 x MON-ØØØ21-9, gene: pat), 3272 x Bt11 x MIR604 (event code: SYN-E3272-5 x SYN-BTØ11-1 x SYN-IR6Ø4-5, gene: pat), 3272 x BT11 x MIR604 x GA21 (event code: SYN-E3272-5 x SYN-BTØ11-1 x SYN-IR6Ø4-5 x MON-ØØØ21-9, gene: pat), 33121 (event code: DP-Ø33121-3, gene: pat), 4114 (event code: DP-ØØ4114-3, gene: pat), 59122 x GA21 (event code: DAS-59122-7 x MON-ØØØ21-9, gene: pat), 59122 x MIR604 (event code: DAS-59122-7 x SYN-IR6Ø4-5, gene: pat), 5307 x MIR604 x Bt11 x TC1507 x GA21 x MIR162 (event code: gene: pat), 59122 x MIR604 x GA21 (event code: DAS-59122-7 x SYN-IR6Ø4-5 x MON-ØØØ21-9, gene: pat), 59122 x MIR604 x TC1507 (event code: DAS-59122-7 x SYN-IR6Ø4-5 x DAS-Ø15Ø7-1, gene: pat), 59122 x MIR604 x TC1507 x GA21 (event code: gene: pat), (event code: DAS-59122-7 x SYN-IR6Ø4-5 x DAS-Ø15Ø7-1 x MON-ØØØ21-9, gene: pat), 59122 x MON810 (event code: DAS-59122-7 x MON-ØØ81Ø-6, gene: pat), 59122 x MON810 x NK603 (event code: DAS-59122-7 x MON-ØØ81Ø-6 x MON-ØØ6Ø3-6, gene: pat), 59122 x TC1507 x GA21 (event code: DAS-59122-7 x DAS-Ø15Ø7-1 x MON-ØØØ21-9, gene: pat), 676 (event code: PH-ØØØ676-7, gene: pat), 678 (event code: PH-ØØØ678-9, gene: pat), 680 (event code: PH-ØØØ680-2, gene: pat), 98140 x 59122 (event code: DP-Ø98140-6 x DAS-59122-7, gene: pat), 98140 x TC1507 (event code: DP-Ø98140-6 x DAS-Ø15Ø7-1, gene: pat), 98140 x TC1507 x 59122 (event code: DP-Ø98140-6 x DAS-Ø15Ø7-1 x DAS-59122-7, gene: pat), 59122 x MON88017 (event code: DAS-59122-7 x MON-88Ø17-3, gene: pat), Bt11 x 59122 (event code: SYN-BTØ11-1 x DAS-59122-7, gene: pat), Bt11 x 59122 x GA21 (event code: SYN-BTØ11-1 x DAS-59122-7 x MON-ØØØ21-9, gene: pat), Bt11 x 59122 x MIR604 (event code: SYN-BTØ11-1 x DAS-59122-7 x SYN-IR6Ø4-5, gene: pat), Bt11 x 59122 x MIR604 x GA21 (event code: SYN-BTØ11-1 x DAS-59122-7 x SYN-IR6Ø4-5 x MON-ØØØ21-9, gene: pat), Bt11 x 59122 x MIR604 x TC1507 (event code: Bt11 x 59122 x MIR604 x TC1507, gene: pat), Bt11 x 59122 x TC1507 (event code: SYN-BTØ11-1 x DAS-59122-7 x DAS-Ø15Ø7-1, gene: pat), Bt11 x 59122 x TC1507 x GA21 (event code: SYN-BTØ11-1 x DAS-59122-7 x DAS-Ø15Ø7-1 x MON-ØØØ21-9, gene: pat), Bt11 x MIR162 x TC1507 (event code: SYN-BTØ11-1 x SYN-IR162-4 x DAS-Ø15Ø7-1, gene: pat), Bt11 x MIR604 x TC1507 (event code: SYN-BTØ11-1 x SYN-IR6Ø4-5 x DAS-Ø15Ø7-1, gene: pat), Bt11 x TC1507 (event code: SYN-BTØ11-1 x DAS-Ø15Ø7-1, gene: pat), Bt11 x TC1507 x GA21 (event code: SYN-BTØ11-1 x DAS-Ø15Ø7-1 x MON-ØØØ21-9, gene: pat), GA21 x T25 (event code: MON-ØØØ21-9 x ACS-ZMØØ3-2, gene: pat), MIR162 x TC1507 (event code: SYN-IR162-4 x DAS-Ø15Ø7-1, gene: pat), MIR162 x TC1507 x GA21 (event code: SYN-IR162-4 x DAS-Ø15Ø7-1 x MON-ØØØ21-9, gene: pat), MIR604 x TC1507 (event code: SYN-IR6Ø4-5 x DAS-Ø15Ø7-1, gene: pat), MON87427 x MON89Ø34 x TC1507 x MON88Ø17 x 59122 (event code: MON-87427-7 x MON-89Ø34-3 x DAS-Ø15Ø7-1 x MON-88Ø17-3 x DAS-59122-7, gene: pat), MON89034 x 59122 (event code: MON-89Ø34-3 x DAS-59122-7, gene: pat), MON89034 x 59122 x MON88017 (event code: gene: pat), MON89034 x TC1507 (event code: MON-89Ø34-3 x DAS-59122-7 x MON-88Ø17-3, gene: pat), (event code: MON-89Ø34-3 x DAS-Ø15Ø7-1, gene: pat), MIR604 x TC1507 (event code: SYN-IR6Ø4-5 x DAS-Ø15Ø7-1, gene: pat), MON87427 x MON89Ø34 x TC1507 x MON88Ø17 x 59122 (event code: MON-87427-7 x MON-89Ø34-3 x DAS-Ø15Ø7-1 x MON-88Ø17-3 x DAS-59122-7, gene: pat), MON89Ø34 x 59122 (event code: MON-89Ø34-3 x DAS-59122-7, gene: pat), MON89034 x 59122 x MON88017 (event code: gene: pat), MON89034 x TC1507 (event code: MON-89Ø34-3 x DAS-59122-7 x MON-88Ø17-3, gene: pat), (event code: MON-89Ø34-3 x DAS-Ø15Ø7-1, gene: pat), DLL25 (B16) (event code: DKB-8979Ø-5, gene: bar), MIR604 x TC1507 (event code: SYN-IR6Ø4-5 x DAS-Ø15Ø7-1, gene: pat), MON87427 x MON89Ø34 x TC1507 x MON88Ø17 x 59122 (event code: MON-87427-7 x MON-89Ø34-3 x DAS-Ø15Ø7-1 x MON-88Ø17-3 x DAS-59122-7, gene: pat), MON89034 x 59122 (event code: MON-89Ø34-3 x DAS-59122-7, gene: pat), MON89034 x 59122 x MON88017 (event code: MON-89Ø34-3 x DAS-59122-7 x MON-88Ø17-3, gene: pat), MON89034 x TC1507 (event code: MON-89Ø34-3 x DAS-Ø15Ø7-1, gene: pat), MON89034 x TC1507 x 59122 (event code: MON-89Ø34-3 x DAS-Ø15Ø7-1 x DAS-59122-7, gene: pat), MON89034 x TC1507 x MON88017 (event code: MON-89Ø34-3 x DAS-Ø15Ø7-1 x MON-88Ø17-3, gene: pat), MON89034 x TC1507 x MON88017 x 59122 x DAS40278 (event code: MON-89Ø34-3 x DAS-Ø15Ø7-1 x MON-88Ø17-3 x DAS-59122-7 x DAS-4Ø278-9, gene: pat), MON89Ø34 x TC1507 x MON88017 x DAS40278 (event code: MON-89Ø34-3 x DAS-Ø15Ø7-1 x MON-88Ø17-3 x DAS-59122-7 x DAS-4Ø278-9, gene: pat), MON89034 x TC1507 x NK603 x DAS40278 (event code: MON-89Ø34-3 x DAS-Ø15Ø7-1 x MON-ØØ6Ø3-6 x DAS-4Ø278-9, gene: pat), NK603 x MON810 x 4114 x MIR 604 (event code: MON-00603-6 x MON-00810-6 x DP004114-3 x SYN-IR604-4, gene: pat), TC1507 x MON810 x MIR604 x NK603 (event code: DAS-Ø15Ø7-1 x MON-ØØ81Ø-6 x SYN-IR6Ø4-5 x MON-ØØ6Ø3-6, gene: pat), TC1507 x 59122 x MON810 (event code: DAS-Ø15Ø7-1 x DAS-59122-7 x MON-ØØ81Ø-6, gene: pat), TC1507 x 59122 x MON88017 (event code: DAS-Ø15Ø7-1 x DAS-59122-7 x MON-88Ø17-3, gene: pat), TC1507 x GA21 (event code: DAS-Ø15Ø7-1 x MON-ØØØ21-9, gene: pat), TC1507 x MON810 (event code: DAS-Ø15Ø7-1 x MON-ØØ81Ø-6, gene: pat), TC1507 x MON810 x MIR162 x NK603 (event code: DAS-Ø15Ø7-1 x MON-ØØ81Ø-6 x SYN-IR162-4 x MON-ØØ6Ø3-6, gene: pat), 3272 x Bt11 x MIR604 x TC1507 x 5307 x GA21 (event code: SYN-E3272-5 x SYN-BTØ11-1 x SYN-IR6Ø4-5 x DAS-Ø15Ø7-1 x SYN-Ø53Ø7-1 x MON-ØØØ21-9, gene: pat), TC1507 x MIR162 x NK603 (event code: DAS-Ø15Ø7-1 x SYN-IR162-4 x MON-ØØ6Ø3-6, gene: pat), TC1507 x MON810 x MIR162 (event code: DAS-Ø15Ø7-1 x MON-ØØ81Ø-6 x SYN-IR162-4, gene: pat), MON87419 (event code: MON87419-8, gene: pat), TC1507 x MON88017 (event code: DAS-Ø15Ø7-1 x MON-88Ø17-3, gene: pat), TC6275 (event code: DAS-Ø6275-8, gene: bar), MZHGOJG (event code: SYN-ØØØJG-2, gene: pat), MZIR098 (event code: SYN-ØØØ98-3, gene: pat), Bt11 x MIR162 x MON89034 (event code: SYN-BTØ11-1 x SYN-IR162-4 x MON-89Ø34-3, gene: pat) and Bt11 x MIR162 x MON89Ø34 x GA21 (event code: SYN-BTØ11-1 x SYN-IR162-4 x MON-89Ø34-3 x MON-ØØØ21-9, gene: pat), 59122 x DAS40278 (event code: DAS-59122-7 x DAS-4Ø278-9, gene: pat), 59122 x MON810 x MIR604 (event code: DAS-59122-7 x MON-ØØ81Ø-6 x SYN-IR6Ø4-5, gene: pat), 59122 x MON810 x NK603 x MIR604 (event code: DAS-59122-7 x MON-ØØ81Ø-6 x MON-ØØ6Ø3-6 x SYN-IR6Ø4-5, gene: pat), 59122 x MON88017 x DAS40278 (event code: DAS-59122-7 x MON-88Ø17-3 x DAS-4Ø278-9, gene: pat), 59122 x NK603 x MIR604 (event code: DAS-59122-7 x MON-ØØ6Ø3-6 x SYN-IR6Ø4-5, gene: pat), Bt11 x 5307 (event code: SYN-BTØ11-1 x SYN-Ø53Ø7-1, gene: pat), Bt11 x 5307 x GA21 (event code: SYN-BTØ11-1 x SYN-Ø53Ø7-1 x MON-ØØØ21-9, gene: pat), Bt11 x M IR162 x 5307 (event code: SYN-BTØ11-1 x SYN-IR162-4 x SYN-Ø53Ø7-1, gene: pat), Bt11 x MIR162 x 5307 x GA21 (event code: SYN-BTØ11-1 x SYN-IR162-4 x SYN-Ø53Ø7-1 x MON-ØØØ21-9, gene: pat), BT11 x MIR162 x MIR604 x 5307 (event code: SYN-BTØ11-1 x SYN-IR162-4 x SYN-IR6Ø4-5 x SYN-Ø53Ø7-1, gene: pat), Bt11 x MIR162 x MIR604 x 5307 x GA21 (event code: SYN-BTØ11-1 x SYN-1R162-4 x SYN-1R604-5 x SYN-Ø53Ø7-1 x MON-ØØØ21-9, gene: pat), Bt11 x MIR162 x MIR604 x MON89034 x 5307 x GA21 (event code: SYN-BTØ11-1 x SYN-IR162-4 x SYN-IR6Ø4-5 x MON-89Ø34-3 x SYN-Ø53Ø7-1 x MON-ØØØ21-9, gene: pat), BT11 x MIR162 x MIR604 x TC1507 (event code: SYN-BTØ11-1 x SYN-1R162-4 x SYN-1R604-5 x DAS-Ø15Ø7-1, gene: pat), BT11 x MIR162 x MIR604 x TC1507 x 5307 (event code: SYN-BTØ11-1 x SYN-IR162-4 x SYN-IR6Ø4-5 x DAS-Ø15Ø7-1 x SYN-Ø53Ø7-1, gene: pat), Bt11 x MIR162 x MIR604 x TC1507 x GA21 (event code: SYN-BTØ11-1 x SYN-IR162-4 x SYN-IR6Ø4-5 x DAS-Ø15Ø7-1 x MON-ØØØ21-9, gene: pat), Bt11 x MIR162 x TC1507 x 5307 (event code: SYN-BTØ11-1 x SYN-IR162-4 x DAS-Ø15Ø7-1 x SYN-Ø53Ø7-1, gene: pat), BT11 x MIR162 x MIR604 x TC1507 x 5307 (event code: SYN-BTØ11-1 x SYN-IR162-4 x SYN-1R604-5 x DAS-Ø15Ø7-1 x SYN-Ø53Ø7-1, gene: pat), Bt11 x MIR162 x MIR604 x TC1507 x GA21 (event code: SYN-BTØ11-1 x SYN-IR162-4 x SYN-IR6●4-5 x DAS-Ø15Ø7-1 x MON-ØØØ21-9, gene: pat), Bt11 x MIR162 x TC1507 x 5307 (event code: SYN-BTØ11-1 x SYN-IR162-4 x DAS-Ø15Ø7-1 x SYN-Ø53Ø7-1, gene: pat), Bt11 x MIR162 x TC1507 x 5307 x GA21 (event code: SYN-BTØ11-1 x SYN-IR162-4 x DAS-Ø15Ø7-1 x SYN-Ø53Ø7-1 x MON-ØØØ21-9, gene: pat), Bt11 x MIR604 x 5307 (event code: SYN-BTØ11-1 x SYN-1R604-5 x SYN-Ø53Ø7-1, gene: pat), Bt11 x MIR604 x 5307 x GA21 (event code: SYN-BTØ11-1 x SYN-IR6Ø4-5 x SYN-Ø53Ø7-1 x MON-ØØØ21-9, gene: pat), Bt11 x MIR604 x TC1507 x 5307 (event code: SYN-BTØ11-1 x SYN-IR6Ø4-5 x DAS-Ø15Ø7-1 x SYN-Ø53Ø7-1, gene: pat), Bt11 x MIR604 x TC1507 x GA21 (event code: SYN-BTØ11-1 x SYN-IR6Ø4-5 x DAS-Ø15Ø7-1 x MON-ØØØ21-9, gene: pat), Bt11 x MON89034 (or Bt11 x MON89Ø34) (event code: SYN-BTØ11-1 x MON-89Ø34-3, gene: pat), Bt11 x MON89034 x GA21 (event code: SYN-BTØ11-1 x MON-89Ø34-3 x MON-ØØØ21-9, gene: pat), Bt11 x MON89Ø34 x GA21 (event code: SYN-BTØ11-1 x MON-89Ø34-3 x MON-ØØØ21-9, gene: pat), Bt11 x TC1507 x 5307 (event code: SYN-BTØ11-1 x DAS-Ø15Ø7-1 x SYN-Ø53Ø7-1, gene: pat), Bt11 x TC1507 x 5307 x GA21 (event code: SYN-BTØ11-1 x DAS-Ø15Ø7-1 x SYN-Ø53Ø7-1 x MON-ØØØ21-9, gene: pat), MIR162 x MIR604 x TC1507 x 5307 (event code: SYN-1R162-4 x SYN-1R604-5 x DAS-Ø15Ø7-1 x SYN-Ø53Ø7-1, gene: pat), MIR162 x MIR604 x TC1507 x 5307 x GA21 (event code: SYN-IR162-4 x SYN-IR6Ø4-5 x DAS-Ø15Ø7-1 x SYN-Ø53Ø7-1 x MON-ØØØ21-9, gene: pat), MIR162 x MIR604 x TC1507 x GA21 (event code: SYN-IR162-4 x SYN-IR6Ø4-5 x DAS-Ø15Ø7-1 x MON-ØØØ21-9, gene: pat), MIR162 x TC1507 x 5307 (event code: SYN-IR162-4 x DAS-Ø15Ø7-1 x SYN-Ø53Ø7-1, gene: pat), MIR162 x TC1507 x 5307 x GA21 (event code: SYN-IR162-4 x DAS-Ø15Ø7-1 x SYN-Ø53Ø7-1 x MON-ØØØ21-9, gene: pat), MIR604 x TC1507 x 5307 (event code: SYN-IR6Ø4-5 x DAS-Ø15Ø7-1 x SYN-Ø53Ø7-1, gene: pat), MIR162 x TC1507 x 5307 (event code: SYN-IR162-4 x DAS-Ø15Ø7-1 x SYN-Ø53Ø7-1, gene: pat), MIR162 x TC1507 x 5307 x GA21 (event code: SYN-IR162-4 x DAS-Ø15Ø7-1 x SYN-Ø53Ø7-1 x MON-ØØØ21-9, gene: pat), MIR604 x TC1507 x 5307 (event code: SYN-IR6Ø4-5 x DAS-Ø15Ø7-1 x SYN-Ø53Ø7-1, gene: pat), MIR604 x TC1507 x 5307 x GA21 (event code: SYN-IR6Ø4-5 x TC1507 x SYN-Ø53Ø7-1 x MON-ØØØ21-9, gene: pat), MIR604 x TC1507 x GA21 (event code: SYN-IR6Ø4-5 x TC1507 x MON-ØØØ21-9, gene: pat), MON87427 x 59122 (event code MON-87427-7 x DAS-59122-7, gene: pat), MON87427 x MON89034 x 59122 (event code: MON-87427-7 x MON-89Ø34-3 x DAS-59122-7, gene: pat), MON87427 x MON89034 x MON88017 x 59122 (event code: MON-87427-7 x MON-89Ø34-3 x MON-88Ø17-3 x 59122, gene: pat), MON87427 x MON89034 x TC1507 (event code: MON-87427-7 x MON-89Ø34-3 x DAS-Ø15Ø7-1, gene: pat), MON87427 x MON89034 x TC1507 x 59122 (event code: MON-87427-7 x MON-89Ø34-3 x DAS-Ø15Ø7-1 x DAS-59122-7, gene: pat), MON87427 x MON89034 x TC1507 x MON87411 x 59122 (event code: MON-87427-7 x MON-89Ø34-3 x DAS-Ø15Ø7-1 x MON-87411-9 x DAS-59122-7, gene: pat), MON87427 x MON89034 x TC1507 x MON87411 x 59122 x DAS40278 (event code: MON-87427-7 x MON-89Ø34-3 x DAS-Ø15Ø7-1 x MON-87411-9 x DAS-59122-7 x DAS-4Ø278-9, gene: pat), MON87427 x MON89034 x TC1507 x MON88Ø17 (event code: MON-87427-7 x MON-89Ø34-3 x DAS-Ø15Ø7-1 x MON-88Ø17-3, gene: pat), MON87427 x TC1507 (event code: MON-87427-7 x DAS-Ø15Ø7-1, gene: pat), MON87427 x TC1507 x 59122 (event code: MON-87427-7 x DAS-Ø15Ø7-1 x DAS-59122-7, gene: pat), MON87427 x TC1507 x MON88017 (event code: MON-87427-7 x DAS-Ø15Ø7-1 x MON-88Ø17-3, gene: pat), MON87427 x TC1507 x MON88017 x 59122 (event code: MON-87427-7 x DAS-Ø15Ø7-1 x MON-88Ø17-3 x DAS-59122-7, gene: pat), MON89034 x 59122 x DAS40278 (event code: MON-89Ø34-3 x DAS-59122-7 x DAS-40278-9, gene: pat), MON89034 x 59122 x MON88017 x DAS40278 (event code: MON-89Ø34-3 x DAS-59122-7 x MON-88Ø17-3 x DAS-4Ø278-9, gene: pat), MON89034 x TC1507 x 59122 x DAS40278 (event code: MON-89Ø34-3 x DAS-Ø15Ø7-1 x DAS-59122-7 x DAS-4Ø278-9, gene: pat), MON89034 x TC1507 x DAS40278 (event code: MON-89Ø34-3 x DAS-Ø15Ø7-1 x DAS-4Ø278-9, gene: pat), MON89034 x TC1507 x NK603 x MIR162 (event code: MON-89Ø34-3 x DAS-Ø15Ø7-1 x MON-ØØ6Ø3-6 x SYN-IR162-4, gene: pat), TC1507 x 5307 (event code: DAS-Ø15Ø7-1 x SYN-Ø53Ø7-1, gene: pat), TC1507 x 5307 x GA21 (event code: DAS-Ø15Ø7-1 x SYN-Ø53Ø7-1 x MON-ØØØ21-9, gene: pat), TC1507 x 59122 x DAS40278 (event code: DAS-Ø15Ø7-1 x DAS-59122-7 x DAS-4Ø278-9, gene: pat), TC1507 x 59122 x MON810 x MIR604 (event code: DAS-Ø15Ø7-1 x DAS-59122-7 x MON-ØØ81Ø-6 x SYN-IR6Ø4-5, gene: pat), TC1507 x 59122 x MON88017 x DAS40278 (event code: DAS-Ø15Ø7-1 x DAS-59122-7 x MON-88Ø17-3 x DAS-4Ø278-9, gene: pat), TC1507 x 59122 x NK603 x MIR604 (event code: gene: pat) DAS-Ø15Ø7-1 x DAS-59122-7 x MON-ØØ6Ø3-6 x SYN-IR6Ø4-5, TC1507 x DAS40278 (event code: DAS-Ø15Ø7-1 x DAS-4Ø278-9, gene: pat), TC1507 x MON810 x MIR604 (event code: DAS-Ø15Ø7-1 x MON-ØØ81Ø-6 x SYN-IR6Ø4-5, gene: pat), TC1507 x MON810 x NK603 x MIR604 (event code: DAS-Ø15Ø7-1 x MON-ØØ81Ø-6 x MON-ØØ6Ø3-6 x SYN-IR6Ø4-5, gene: pat), TC1507 x MON88017 x DAS40278 (event code: DAS-Ø15Ø7-1 x MON-88Ø17-3 x DAS-4Ø278-9, gene: pat) and TC1507 x NK603 x DAS40278 (event code: DAS-Ø15Ø7-1 x MON-ØØ6Ø3-6 x DAS-40278-9, gene: pat).

Transgenic soybean events comprising glufosinate tolerance genes are for example, but not excluding others, A2704-12 (event code: ACS-GMØØ5-3, gene: pat, e.g. commercially available as Liberty Link™ soybean), A2704-21 (event code: ACS-GMØØ4-2, gene: pat, e.g. commercially available as Liberty Link™ soybean), A5547-127 (event code: ACS-GMØØ6-4, gene: pat, e.g. commercially available as Liberty Link™ soybean), A5547-35 (event code: ACS-GMØØ8-6, gene: pat, e.g. commercially available as Liberty Link™ soybean), GU262 (event code: ACS-GMØØ3-1, gene: pat, e.g. commercially available as Liberty Link™ soybean), W62 (event code: ACS-GMØØ2-9, gene: pat, e.g. commercially available as Liberty Link™ soybean), W98 (event code: ACS-GMØØ1-8, gene: pat, e.g. commercially available as Liberty Link™ soybean), DAS68416-4 (event code: DAS-68416-4, gene: pat, e.g. commercially available as Enlist™ Soybean), DAS44406-6 (event code: DAS-44406-6, gene: pat), DAS68416-4 x MON89788 (event code: DAS-68416-4 x MON-89788-1, gene: pat), SYHTØH2 (event code: SYN-ØØØH2-5, gene: pat), DAS81419 x DAS44406-6 (event code: DAS-81419-2 x DAS-44406-6, gene: pat) and FG72 x A5547-127 (event code: MST-FGØ72-3 x ACS-GMØØ6-4, gene: pat).

Transgenic cotton events comprising glufosinate tolerance genes are for example, but not excluding others, 3006-210-23 x 281-24-236 x MON1445 (event code: DAS-21Ø23-5 x DAS-24236-5 x MON-Ø1445-2, gene: bar, e.g. commercially available as WideStrike™ Roundup Ready™ Cotton), 3006-210-23 x 281-24-236 x MON88913 (event code: DAS-21Ø23-5 x DAS-24236-5 x MON-88913-8, gene: bar, e.g. commercially available as Widestrike™ Roundup Ready Flex™ Cotton), 3006-210-23 x 281-24-236 x MON88913 x COT102 (event code: DAS-21Ø23-5 x DAS-24236-5 x MON-88913-8 x SYN-IR1Ø2-7, gene: pat, e.g. commercially available as Widestrike™ x Roundup Ready Flex™ x VIPCOT™ Cotton), GHB614 x LLCotton25 (event code: BCS-GHØØ2-5 x ACS-GHØØ1-3, gene: bar, e.g. commercially available as GlyTol™ Liberty Link™), GHB614 x T304-40 x GHB119 (event code: BCS-GHØØ2-5 x BCS-GHØØ4-7 x BCS-GHØØ5-8, gene: bar, e.g. commercially available as Glytol™ x Twinlink™), LLCotton25 (event code: ACS-GHØØ1-3, gene: bar, e.g. commercially available as ACS-GHØØ1-3), GHB614 x T304-40 x GHB119 x COT102 (event code: BCS-GHØØ2-5 x BCS-GHØØ4-7 x BCS-GHØØ5-8 x SYN-IR1Ø2-7, gene: bar, e.g. commercially available as Glytol™ x Twinlink™ x VIPCOT™ Cotton), LLCotton25 x MON15985 (event code: ACS-GHØØ1-3 x MON-15985-7, gene: bar, e.g. commercially available as Fibermax™ Liberty Link™ Bollgard II™), T304-40 x GHB119 (event code: BCS-GHØØ4-7 x BCS-GHØØ5-8, gene: bar, e.g. commercially available as TwinLink™ Cotton), GHB614 x T304-40 x GHB119 x COT102 (event code: BCS-GHØØ2-5 x BCS-GHØØ4-7 x BCS-GHØØ5-8 x SYN-IR1Ø2-7, gene: bar, e.g. commercially available as Glytol™ X Twinlink™ x VIPCOT™ Cotton), GHB119 (event code: BCS-GHØØ5-8, gene: bar), GHB614 x LLCotton25 x MON15985 (event code: CS-GHØØ2-5 x ACS-GHØØ1-3 x MON-15985-7, gene: bar), MON 887Ø1-3 (event code: MON887Ø1, gene: bar), T303-3 (event code: BCS-GHØØ3-6, gene: bar), T304-40 (event code: BCS-GHØØ3-6, gene: bar), (event code: BCS-GHØØ4-7, gene: bar), 81910 (event code: DAS-81910-7, gene: pat), MON8870 (event code: MON 887Ø1-3, gene: bar), MON88701 x MON88913 (event code: MON 887Ø1-3 x MON-88913-8, gene: bar), MON88701 x MON88913 x MON15985 (event code: MON 887Ø1-3 x MON-88913-8 x MON-15985-7, gene: bar), 281-24-236 x 3006-210-23 x COT102 x 81910 (event code: DAS-24236-5 x DAS-21Ø23-5 x SYN-IR1Ø2-7 x DAS-81910-7, gene: pat), COT102 x MON15985 x MON88913 x MON88701 (event code: SYN-IR1Ø2-7 x MON-15985-7 x MON-88913-8 x MON 887Ø1-3, gene: bar) and 3006-210-23 x 281-24-236 x MON88913 x COT102 x 81910 (event code: DAS-21Ø23-5 x DAS-24236-5 x MON-88913-8 x SYN-IR1Ø2-7 x DAS-81910-7, gene: pat).

Transgenic canola events comprising glufosinate tolerance genes are for example, but not excluding others, HCN10 (Topas 19/2) (event code: gene: bar, e.g. commercially available as Liberty Link™ Independence™), HCN28 (T45) (event code: ACS-BNØØ8-2, gene: pat, e.g. commercially available as InVigor™ Canola), HCN92 (Topas 19/2 (event code: ACS-BNØØ7-1, gene: bar, e.g. commercially available as Liberty Link™ Innovator™), MS1 (B91-4) (event code: ACS-BNØØ4-7, gene: bar, e.g. commercially available as InVigor™ Canola), MS1 x RF1 (PGS1) (event code: ACS-BNØØ4-7 x ACS-BNØØ1-4, gene: bar, e.g. commercially available as InVigor™ Canola), MS1 x RF2 (PGS2) (event code: ACS-BNØØ4-7 x ACS-BNØØ2-5, gene: bar, e.g. commercially available as InVigor™ Canola), MS1 x RF3 (event code: ACS-BNØØ4-7 x ACS-BNØØ3-6, gene: bar, e.g. commercially available as InVigor™ Canola), MS8 (event code: ACS-BNØØ5-8, gene: bar, e.g. commercially available as InVigor™ Canola), MS8 x RF3 (event code: ACS-BNØØ5-8 x ACS-BNØØ3-6, gene: bar, e.g. commercially available as InVigor™ Canola), RF1 (B93-101) (event code: ACS-BN001-4, gene: bar, e.g. commercially available as InVigor™ Canola), RF2 (B94-2) (event code: ACS-BNØØ2-5, gene: bar, e.g. commercially available as InVigor™ Canola), RF3 (event code: ACS-BNØØ3-6, gene: bar, e.g. commercially available as InVigor™ Canola), MS1 x MON88302 (event code: ACS-BNØØ4-7 x MON-883Ø2-9, gene: bar, e.g. commercially available as InVigor™ x TruFlex™ Roundup Ready™ Canola), MS8 x MON88302 (event code: ACS-BNØØ5-8 x MON-883Ø2-9, gene: bar, e.g. commercially available as InVigor™ x TruFlex™ Roundup Ready™ Canola), RF1 x MON88302 (event code: ACS-BNØØ1-4 x MON-883Ø2-9, gene: bar, e.g. commercially available as InVigor™ x TruFlex™ Roundup Ready™ Canola), RF2 x MON88302 (event code: ACS-BNØØ2-5 x MON-883Ø2-9, gene: bar, e.g. commercially available as InVigor™ x TruFlex™ Roundup Ready™ Canola), HCN28 x MON88302 (event code: ACS-BNØØ8-2 x MON-883Ø2-9, gene: pat, e.g. commercially available as InVigor™ x TruFlex™ Roundup Ready™ Canola), HCN92 x MON88302 (event code: ACS-BNØØ7-1 x MON-883Ø2-9, gene: bar, e.g. commercially available as Liberty Link™ Innovator™ x TruFlex™ Roundup Ready™ Canola), HCR-1 (gene: pat), MON88302 x MS8 x RF3 (event code: MON-883Ø2-9 x ACS-BNØØ5-8 x ACS-BNØØ3-6, gene: bar), MON88302 x RF3 (event code: MON-883Ø2-9 x ACS-BNØØ3-6, gene: bar), MS8 x RF3 x GT73 (RT73) (event code: gene: bar), PHY14 (event code: ACS-BNØØ5-8 x ACS-BNØØ3-6 x MON-ØØØ73-7, gene: bar), PHY23 (gene: bar), PHY35 (gene: bar) and PHY36 (gene: bar) and 73496 x RF3 (event code: DP-Ø73496-4 x ACS-BNØØ3-6, gene: bar).

Transgenic rice events comprising glufosinate tolerance genes are for example, but not excluding others, LLRICE06 (event code: ACS-OSØØ1-4, e.g. commercially available as Liberty Link™ rice), LLRICE601 (event code: BCS—OSØØ3-7, e.g. commercially available as Liberty Link™ rice) and LLRICE62 (event code: ACS-OSØØ2-5, e.g. commercially available as Liberty Link™ rice).

The application of the combination of the herbicide and the copolymer CP provides an outstanding herbicidal activity against a broad spectrum of economically important harmful monocotyledonous and dicotyledonous harmful plants. Also here, post-emergence application is preferred.

Specifically, examples may be mentioned of some representatives of the monocotyledonous and dicotyledonous weed flora which can be controlled by the combinations according to the invention, without the enumeration being a restriction to certain species.

In the context of the present text, reference may be made to growth stages according to the BBCH monograph “Growth stages of mono- and dicotyledonous plants”, 2nd edition, 2001, ed. Uwe Meier, Federal Biological Research Centre for Agriculture and Forestry (Biologische Bundesanstalt für Land und Forstwirtschaft).

Examples of monocotyledonous harmful plants on which the glufosinate combinations act efficiently are from amongst the genera Hordeum spp., Echinochloa spp., Poa spp., Bromus spp., Digitaria spp., Eriochloa spp., Setaria spp., Pennisetum spp., Eleusine spp., Eragrostis spp., Panicum spp., Lolium spp., Brachiaria spp., Leptochloa spp., Avena spp., Cyperus spp., Axonopris spp., Sorghum spp., and Melinus spp.

Particular examples of monocotyledonous harmful plants species on which the herbicidal compositions act efficiently are selected from amongst the species Hordeum murinum, Echinochloa crus-galli, Poa annua, Bromus rubens L., Bromus rigidus, Bromus secalinus L., Digitaria sanguinalis, Digitaria insularis, Eriochloa gracilis, Setaria faberi, Setaria viridis, Pennisetum glaucum, Eleusine indica, Eragrostis pectinacea, Panicum miliaceum, Lolium multiflorum, Brachiaria platyphylla, Leptochloa fusca, Avena fatua, Cyperus compressus, Cyperus esculentes, Axonopris offinis, Sorghum halapense, and Melinus repens.

In a preferred embodiment, the herbicidal compositions are used to control monocotyledonous harmful plant species, more preferably monocoty-ledonous plants of the species Echinochloa spp., Digitaria spp., Setaria spp., Eleusine spp. and Bra-chiarium spp.

Examples of dicotyledonous harmful plants on which the herbicidal compositions act efficiently are from amongst the genera Amaranthus spp., Erigeron spp., Conyza spp., Polygonum spp., Medicago spp., Mollugo spp., Cyclospermum spp., Stellaria spp., Gnaphalium spp., Taraxacum spp., Oenothera spp., Amsinckia spp., Erodium spp., Erigeron spp., Senecio spp., Lamium spp., Kochia spp., Chenopodium spp., Lactuca spp., Malva spp., Ipomoea spp., Brassica spp., Sinapis spp., Urtica spp., Sida spp, Portulaca spp., Richardia spp., Ambrosia spp., Calandrinia spp., Sisymbrium spp., Sesbania spp., Capsella spp., Sonchus spp., Euphorbia spp., Helianthus spp., Coronopus spp., Salsola spp., Abutilon spp., Vicia spp., Epilobium spp., Cardamine spp., Picris spp., Trifolium spp., Galinsoga spp., Epimedium spp., Marchantia spp., Solanum spp., Oxalis spp., Metricaria spp., Plantago spp., Tribulus spp., Cenchrus spp. Bidens spp., Veronica spp., and Hypochaeris spp.

Particular examples of dicotyledonous harmful plants species on which the herbicidal compositions act efficiently are selected from amongst the species Amaranthus spinosus, Polygonum convolvulus, Medicago polymorpha, Mollugo verticillata, Cyclospermum leptophyllum, Stellaria media, Gnaphalium purpureum, Taraxacum officinale, Oenothera laciniata, Amsinckia intermedia, Erodium cicutarium, Erodium moschatum, Erigeron bonariensis (Conyza bonariensis), Senecio vulgaris, Lamium amplexicaule, Erigeron canadensis, Polygonum aviculare, Kochia scoparia, Chenopodium album, Lactuca serriola, Malva parviflora, Malva neglecta, Ipomoea hederacea, Ipomoea lacunose, Brassica nigra, Sinapis arvensis, Urtica dioica, Amaranthus blitoides, Amaranthus retroflexus, Amaranthus hybridus, Amaranthus lividus, Sida spinosa, Portulaca oleracea, Richardia scabra, Ambrosia artemisiifolia, Calandrinia cau-lescens, Sisymbrium irio, Sesbania exaltata, Capsella bursa-pastoris, Sonchus oleraceus, Euphorbia maculate, Helianthus annuus, Coronopus didymus, Salsola tragus, Abutilon theophrasti, Vicia ben-ghalensis L., Epilobium paniculatum, Cardamine spp, Picris echioides, Trifolium spp., Galinsoga spp., Epimedium spp., Marchantia spp., Solanum spp., Oxalis spp., Metricaria matriccarioides, Plantago spp., Tribulus terrestris, Salsola kali, Cenchrus spp., Bidens bipinnata, Veronica spp., and Hypochaeris radicata.

In a preferred embodiment, the herbicidal compositions are used to control dicotyledonous harmful plant species, more preferably dicotyledonous plants of the species Amaranthus spp., Erigeron spp., Conyza spp., Kochia spp. and Abutilon spp.

By applying the aqueous spray liquore a large number of annual and perennial sedge weeds including Cyperus species such as purple nutsedge (Cyperus rotundus L.), yellow nutsedge (Cyperus esculentus L.), hime-kugu (Cyperus brevifolius H.), sedge weed (Cyperus microiria Steud), rice flatsedge (Cyperus iria L.), Cyperus difformis, Cyperus difformis L., Cyperus esculentus, Cyperus ferax, Cyperus flavus, Cyperus iria, Cyperus lanceolatus, Cyperus odoratus, Cyperus rotundus, Cyperus serotinus Rottb., Eleocharis acicularis, Eleocharis kuroguwai, Fimbristylis dichotoma, Fimbristylis miliacea, Scirpus grossus, Scirpus juncoides, Scirpus juncoides Roxb, Scirpus or Bolboschoenus maritimus, Scirpus or Schoenoplectus mucronatus, Scirpus planiculmis Fr. Schmidt and the like.

If the spray liquores are applied post-emergence to the green parts of the plants, growth likewise stops drastically a very short time after the treatment and the weed plants remain at the growth stage of the point of time of application, or they die completely after a certain time, so that in this manner competition by the weeds, which is harmful to the crops, is eliminated at a very early point in time and in a sustained manner.

Applying the combination of the herbicide and the copolymer CP results in a rapidly commencing and long-lasting herbicidal action. As a rule, the rainfastness of the herbicide active compounds in the combination according to the present invention is advantageous. In particular when the herbicidal compositions are employed application rates may be reduced, a broader spectrum of broad-leaved weeds and grass weeds may be controlled, the herbicidal action may take place more rapidly, the duration of action may be longer, the harmful plants may be controlled better while using only one, or few, applications, and the application period which is possible to be extended.

The abovementioned properties and advantages are of benefit for weed control practice to keep agricultural crops free from undesired competing plants and thus to safeguard and/or increase the yields from the qualitative and/or quantitative point of view. These herbicidal compositions markedly exceed the technical state of the art with a view to the properties described.

Owing to their herbicidal and plant-growth-regulatory properties, the herbicidal compositions can be employed for controlling harmful plants in genetically modified crops or crops obtained by mutation/selection. These crops are distinguished as a rule by particular, advantageous properties, such as resistances to herbicidal compositions or resistances to plant diseases or causative agents of plant diseases such as particular insects or microorganisms such as fungi, bacteria or viruses. Other particular properties relate, for example, to the harvested material with regard to quantity, quality, storability, composition and specific constituents. Thus, for example, transgenic plants are known whose starch content is increased or whose starch quality is altered, or those where the harvested material has a different fatty acid composition.

A particular aspect of the present invention also relates to a method of controlling undesired vegetation (e.g. harmful plants), which comprises applying the herbicidal compositions, preferably by the post-emergence method, to harmful or undesired plants, parts of said harmful or undesired plants, or the area where the harmful or undesired plants grow, for example the area under cultivation.

In the context of the present invention “controlling” denotes a significant reduction of the growth of the harmful plant(s) in comparison to the untreated harmful plants. Preferably, the growth of the harmful plant(s) is essentially diminished (60-79%), more preferably the growth of the harmful plant(s) is largely or fully suppressed (80-100%), and in particular the growth of the harmful plant(s) is almost fully or fully suppressed (90-100%).

Thus, in a further aspect, the present invention relates to a method for controlling undesired plant growth, and/or controlling harmful plants, comprising the step of applying the aqueous spray liquor containing a combination of the herbicide and the copolymer CP, preferably in one of the preferred embodiments defined herein, onto the undesired plants or the harmful plants, on parts of the undesired plants or the harmful plants, or on the area where the undesired plants or the harmful plants grow.

The aqueous spray liquor containing the combination of the herbicide and the copolymer CP may be used for controlling undesirable vegetation in burndown programs, in industrial vegetation management and forestry, in vegetable and perennial crops and in turf and lawn, wherein the herbicidal composition(s) can be applied pre- or post-emergence, i.e. before, during and/or after emergence of the undesirable plants. Preferred is the application as post-emergence treatment, i.e. during and/or after emergence of the undesirable plants. Herein, the herbicidal composition(s) are applied to a locus where crops will be planted before planting or emergence of the crop.

In industrial weed management and forestry, it is desirable to control a broad range of weeds for an extended period of time. The control of large weeds, or taller species such as bushes or trees may also be desirable. Industrial weed management includes for example railway and right-of-way management, fence lines and non-crop land such as industrial and building sites, gravel areas, roads or sidewalks. Forestry includes for example the clearing of existing forest or bushland, the removal of regrowth after mechanical forest cutting, or the management of weeds under forestry plantations. In the latter case, it may be desirable to shield desirable trees from contact with the spray solution that contains the herbicidal mixture according to the present invention.

The aqueous spray liquor containing the combination of the herbicide and the copolymer CP can also be used for weed control in turf and lawn provided the desirable grass species are tolerant to herbicidal composition. In particular, such herbicidal compositions can be used in desirable grass that has been rendered tolerant to the respective agrochemical active ingredient, e.g. glufosinate or its salts, by mutagenesis or genetic engineering.

Glufosinate and its salts are non-selective systemic herbicides having a good post-emergence activity against numerous weeds and thus can be used in burndown programs, in industrial vegetation management and forestry, in vegetable and perennial crops and in turf and lawn.

Therefore, the present invention also relates to a method for burndown treatment of undesirable vegetation in crops, comprising applying the aqueous spray liquor containing the combination of the herbicide and the copolymer CP to a locus where crops will be planted before planting (or seeding) or emergence of the crop. Herein, the herbicidal composition is applied undesirable vegetation or the locus thereof.

The present invention also relates to a method for controlling undesirable vegetation, which method comprises applying the aqueous spray liquor containing the combination of the herbicide and the copolymer CP to a locus where undesirable vegetation is present or is expected to be present. The application may be done before, during and/or after, preferably during and/or after, the emergence of the undesirable vegetation. In one embodiment, the application is carried out before emergence of the crop, which is cultivated at the locus where the undesirable vegetation is present or is expected to be present. In another embodiment, the application is carried out before planting the crop.

In burndown programs, the spray liquors can be applied prior to seeding (planting) or after seeding (or planting) of the crop plants but before the emergence of the crop plants, in particular prior to seeding. The spray liquors are preferably applied prior to seeding of the crop plants. For burndown, the spray liquors will generally be applied a date up to 9 months, frequently up to 6 months, preferably up to 4 months prior to planting the crop. The burndown application can be done at a date up to 1 day prior to emergence of the crop plant and is preferably done at a date prior to seeding/planting of the crop plant, preferably at a date of at least one day, preferably at least 2 days and in particular at least one 4 days prior to planting or from 6 months to 1 day prior emergence, in particular from 4 months to 2 days prior emergence and more preferably from 4 months to 4 days prior emergence. It is, of course, possible to repeat the burndown application once or more, e.g. once, twice, three times, four times or five times within that time frame.

It is a particular benefit of the spray liquor containing the herbicide and the copolymer CP that the application of the spray liquor provides for a very good post-emergence herbicide activity, i.e. they show a good herbicidal activity against emerged undesirable plants. Thus, in a preferred embodiment of invention, the spray liquors are applied post-emergence, i.e. during and/or after, the emergence of the undesirable plants. It is particularly advantageous to apply the spray liquors post emergent when the undesirable plant starts with leaf development up to flowering. The herbicidal compositions are particularly useful for controlling undesirable vegetation which has already developed to a state, which is difficult to control with conventional burndown mixtures, i.e. when the individual weed is taller than 10 cm (4 inches) or even taller than 15 cm (6 inches) and/or for heavy weed populations. In the case of a post-emergence treatment of the plants, the herbicidal compositions are preferably applied by foliar application.

The spray liquors can be applied in conventional manner by using techniques as skilled person is familiar with. Suitable techniques include spraying, atomizing, dusting, spreading or watering. The type of application depends on the intended purpose in a well-known manner; in any case, they should ensure the finest possible distribution of the active ingredients according to the invention.

In one embodiment, the spray liquors are applied to locus mainly by spraying, in particular foliar spraying of an aqueous dilution of the active ingredients of the mixture.

Application can be carried out by customary spraying techniques using spray liquor rates of from about 10 to 2000 I/ha or 50 to 1000 I/ha (for example from 100 to 500 I/ha).

The required application rate of the herbicide active compound via the spray liquor depends on the density of the undesired vegetation, on the development stage of the plants, on the climatic conditions of the location where the mixture is used and on the application method.

In general, the rate of application of L-glufosinate or its salt is usually from 50 g/ha to 3000 g/ha and preferably in the range from 100 g/ha to 2000 g/ha or from 200 g/ha to 1500 g/ha of active substance (a.i.).

The spray liquor containing the copolymer CP and the herbicide provide for a persistent herbicidal activity, even under difficult weathering conditions, which allows a more flexible application in burndown applications and minimizes the risk of weeds escaping. Apart from that, the spray liquor containing the copolymer CP and the herbicide provide for superior crop compatibility with certain conventional crop plants and with herbicide tolerant crop plants, i.e. their use in these crops leads to a reduced damage of the crop plants and/or does not result in increased damage of the crop plants. Thus, the spray liquor containing the copolymer CP can also be applied after the emergence of the crop plants. The spray liquor containing the copolymer CP may also show an accelerated action on harmful plants, i.e. they may affect damage of the harmful plants more quickly.

The spray liquors containing the copolymer CP are also suitable for controlling weeds that are resistant to commonly used herbicides such as, for example, weeds that are resistant to glyphosate, weeds that are resistant to auxin inhibitor herbicides such as e. g. 2,4-D or dicamba, weeds that are resistant to photosynthesis inhibitors such as e. g. atrazine, weeds that are resistant to ALS inhibitors such as e. g. sulfonylureas, imidazolinones or triazolopyrimidines, weeds that are resistant to ACCase inhibitors such as e. g. clodinafop, clethodim or pinoxaden or weeds that are resistant to protoporphyrinogen-IX-oxidase inhibitors such as e. g. sulfentrazone, flumioxazine, fomesafen or acifluorfen, for example the weeds that are listed in the International Survey of Resistant Weeds (http://www.weedscience.org/Summary/SpeciesbySOATable.aspx). In particular, they are suitable for controlling the resistant weeds that are resistant to glufosinate or its salts, such as listed in the International Survey of Resistant Weeds, for example ACCase resistant Echinochloa crus-galli, Avena fatua, Alopecurus myosuroides, Echinochloa colona, Alopecurus japonicus, Bromus tectorum, Hordeum murinum, Ischaemum rugosum, Setaria viridis, Sorghum halepense, Alopecurus aequalis, Apera spica-venti, Avena sterilis, Beckmannia szygachne, Bromus diandrus, Digitaria sanguinalis, Echinocloa oryzoides, Echinochloa phyllopogon, Phalaris minor, Phalaris paradoxa, Setaria faberi, Setaria viridis, Brachypodium distachyon, Bromus diandrus, Bromus sterilis, Cynosurus echinatus, Digitaria insularis, Digitaria ischaemum, Leptochloa chinensis, Phalaris brachystachis, Rotboellia cochinchinensis, Digitaria ciliaris, Ehrharta longiflora, Eriochloa punctata, Leptochloa panicoides, Lolium persicum, Polypogon fugax, Sclerochloa kengiana, Snowdenia polystacha, Sorghum sudanese and Brachiaria plantaginea, ALS inhibitor resistant Echinochloa crus-galli, Poa annua, Avena fatua, Alopecurus myosuroides, Echinochloa colona, Amaranthus hybridus, Amaranthus palmeri, Amaranthus rudis, Conyza sumatrensis, Amaranthus retroflexus, Ambrosia artemisifolia, Conyza canadensis, Kochia scoparia, Raphanus raphanistrum, Senecio vernalis, Alopecurus japonicus, Bidens pilosa, Bromus tectorum, Chenopodium album, Conyza bonariensis, Hordeum murinum, Ischaemum rugosum, Senecio vulgaris, Setaria viridis, Sisymbrium orientale, Sorghum halepense, Alopecurus aequalis, Amaranthus blitum, Amaranthus powellii, Apera spica-venti, Avena sterilis, Brassica rapa, Bromus diandrus, Descurainia sophia, Digitaria sanguinalis, Echinochloa oryzoides, Echinochloa phyllopogon, Euphorbia heterophylla, Lactuca serriola, Phalaris minor, Phalaris paradoxa, Setaria faberi, Setaria viridis, Sinapis arvensis, Solanum ptycanthum, Sonchus oleraceus, Stellaria media, Amaranthus blitoides, Amaranthus spinosus, Amaranthus viridis, Ambrosia trifida, Bidens subalternans, Bromus diandrus, Bromus sterilis, Capsella bursa-pastoris, Centaurea cyanus, Cynosurus echinatus, Cyperus difformis, Fimbristilis miliacea, Galeopsis tetrahit, Galium aparine, Galium spurium, Helianthus annuus, Hirschfeldia incana, Limnocharis flava, Limnophila erecta, Papaver rhoeas, Parthenium hysterophorus, Phalaris brachystachis, Polygonum convolvulus, Polygonum lapathifolium, Polygonum persicaria, Ranunculus acris, Rottboellia cochinchinensis, Sagittaria montevidensis, Salsola tragus, Schoenoplectus mucronatus, Setaria pumila, Sonchus asper, Xanthium strumarium, Ageratum conyzoides, Alisma canaliculatum, Alisma plantago-aquatica, Ammannia auriculata, Ammannia coccinea, Ammannia arvensis, Anthemis cotula, Bacopa rotundifolia, Bifora radians, Blyxa aubertii, Brassica tournefortii, Bromus japonicus, Bromus secalinus, Lithospermum arvense, Camelina microcarpa, Chamaesyce maculata, Chrysanthemum coronarium, Clidemia hirta, Crepis tectorum, Cuscuta pentagona, Cyperus brevifolis, Cyperus compressus, Cyperus esculentus, Cyperus iria, Cyperus odoratus, Damasonium minus, Diplotaxis erucoides, Diplotaxis tenuifolia, Dopatrum junceum, Echium plantagineum, Elatine triandra, Eleocharis acicularis, Erucaria hispanica, Erysimum repandum, Galium tricornutum, Iva xanthifolia, Ixophorus unisetus, Lamium amplexicaule, Limnophilia sessiliflora, Lindernia dubia, Lindernia micrantha, Lindernia procumbens, Ludwigia prostrata, Matricaria recutita, Mesembryanthemum crystallinum, Monochoria korsakowii, Monochoria vaginalis, Myosoton aquaticum, Neslia paniculata, Oryza sativa var. sylvatica, Pentzia suffruticosa, Picris hieracioides, Raphanus sativus, Rapistrum rugosum, Rorippa indica, Rotala indica, Rotala pusilla, Rumex dentatus, Sagittaria guayensis, Sagittaria pygmaea, Sagittaria trifolia, Schoenoplectus fluviatilis, Schoenoplectus juncoides, Schoenoplectus wallichii, Sida spinosa, Silene gallica, Sinapis alba, Sisymbrium thellungii, Sorghum bicolor, Spergula arvensis, Thlaspi arvense, Tripleurospermum perforatum, Vaccaria hispanica and Vicia sativa, photosynthesis inhibitor resistant Echinochloa crus-galli, Poa annua, Alopecurus myosuroides, Echinochloa colona, Amaranthus hybridus, Amaranthus palmeri, Amaranthus rudis, Conyza sumatrensis, Amaranthus retroflexus, Ambrosia artemisifolia, Conyza canadensis, Kochia scoparia, Raphanus raphanistrum, Senecio vernalis, Alopecurus japonicus, Bidens pilosa, Bromus tectorum, Chenopodium album, Conyza bonariensis, Ischaemum rugosum, Senecio vulgaris, Setaria viridis, Sisymbrium orientale, Amaranthus blitum, Amaranthus powellii, Apera spica-venti, Beckmannia syzigachne, Brassica rapa, Digitaria sanguinalis, Euphorbia heterophylla, Phalaris minor, Phalaris paradoxa, Setaria faberi, Setaria viridis, Sinapis arvensis, Solanum ptycanthum, Stellaria media, Amaranthus blitoides, Amaranthus viridis, Bidens subalternans, Brachypodium distachyon, Capsella bursa-pastoris, Chloris barbata, Cyperus difformis, Echinochloa erecta, Epilobium ciliatum, Polygonum aviculare, Polygonum convolvulus, Polygonum lapathifolium, Polygonum persicaria, Portulaca oleracea, Schoenoplectus mucronatus, Setaria pumila, Solanum nigrum, Sonchus asper, Urochloa panicoides, Vulpia bromoides, Abutilon theophrasti, Amaranthus albus, Amaranthus cruentus, Arabidopsis thaliana, Arenaria serpyllifolia, Bidens tripartita, Chenopodium album, Chenopodium ficifolium, Chenopodium polyspermum, Crypsis schoenoides, Datura stramonium, Epilobium tetragonum, Galinsoga ciliata, Matricaria discoidea, Panicum capillare, Panicum dichotomiflorum, Plantago lagopus, Polygonum hydopiper, Polygonum pensylvanicum, Polygonum monspeliensis, Rostraria, smyrnacea, Rumex acetosella, Setaria verticillata and Urtica urens, PS-1-electron diversion inhibitor resistant Poa annua, Conyza sumatrensis, Conyza canadensis, Alopecurus japonicus, Bidens pilosa, Conyza bonariensis, Hordeum murinum, Ischaemum rugosum, Amaranthus blitum, Solanum ptycanthum, Arctotheca calendula, Epilobium ciliatum, Hedyotis verticillata, Solanum nigrum, Vulpia bromoides, Convolvulus arvensis, Crassocephalum crepidioides, Cuphea carthagensis, Erigeron philadelphicus, Gamochaeta pensylvanica, Landoltia punctata, Lepidium virginicum, Mazus fauriei, Mazus pumilus, Mitracarpus hirtus, Sclerochloa dura, Solanum americanum and Youngia japonica, glyphosate resistant Poa annua, Echinochloa colona, Amaranthus hybridus, Amaranthus palmeri, Amaranthus rudis, Conyza sumatrensis, Ambrosia artemisifolia, Conyza canadensis, Kochia scoparia, Raphanus raphanistrum, Bidens pilosa, Conyza bonariensis, Hordeum murinum, Sorghum halepense, Brassica rapa, Bromus diandrus, Lactuca serriola, Sonchus oleraceus, Amaranthus spinosus, Ambrosia trifida, Digitaria insularis, Hedyotis verticillata, Helianthus annuus, Parthenium hysterophorus, Plantago lanceolata, Salsola tragus, Urochloa panicoides, Brachiaria eruciformis, Bromus rubens, Chloris elata, Chloris truncata, Chloris virgata, Cynodon hirsutus, Lactuca saligna, Leptochloa virgata, Paspalum paniculatum and Tridax procumbens, microtubule assembly inhibitor resistant Echinochloa crus-galli, Poa annua, Avena fatua, Alopecurus myosuroides, Amaranthus palmeri, Setaria viridis, Sorghum halepense, Alopecurus aequalis, Beckmannia syzigachne and Fumaria densifloria, auxin herbicide resistant Echinochloa crus-galli, Echinochloa colona, Amaranthus hybridus, Amaranthus rudis, Conyza sumatrensis, Kochia scoparia, Raphanus raphanistrum, Chenopodim album, Sisymbrium orientale, Descurainia sophia, Lactuca serriola, Sinapis arvensis, Sonchus oleraceus, Stellaria media, Arctotheca calendula, Centaurea cyanus, Digitaria ischaemum, Fimbristylis miliacea, Galeopsis tetrahit, Galium aparine, Galium spurium, Hirschfeldia incana, Limnocharis flava, Limnocharis erecta, Papaver rhoeas, Plantago lanceolata, Ranunculus acris, Carduus nutans, Carduus pycnocephalus, Centaurea soltitialis, Centaurea stoebe ssp. Micranthos, Cirsium arvense, Commelina diffusa, Echinochloa crus-pavonis, Soliva sessilis and Sphenoclea zeylanica, HPPD inhibitor resistant Amaranthus palmeri and Amaranthus rudis, PPO inhibitor resistant Acalypha australis, Amaranthus hybridus, Amaranthus palmeri, Amaranthus retroflexus, Amaranthus rudis, Ambrosia artemisifolia, Avena fatua, Conyza sumatrensis, Descurainia sophia, Euphorbia heterophylla and Senecio vernalis, carotenoid biosynthesis inhibitor resistant Hydrilla verticillata, Raphanus raphanistrum, Senecio vernalis and Sisymbrium orientale, VLCFA inhibitor resistant Alopecurus myosuroides, Avena fatua and Echinochloa crus-galli.

The spray liquors containing the copolymer CP are suitable for combating/controlling common harmful plants in fields, where useful plants shall be planted (i.e. in crops). The inventive mixtures are generally suitable, such as for burndown of undesired vegetation, in fields of the following crops:
Grain crops, including e.g. cereals (small grain crops) such as wheat (Triticum aestivum) and wheat like crops such as durum (T. durum), einkorn (T. monococcum), emmer (T. dicoccon) and spelt (T. spelta), rye (Secale cereale), triticale (Tritiosecale), barley (Hordeum vulgare); maize (corn; Zea mays); sorghum (e.g. Sorghum bicolour); rice (Oryza spp. such as Oryza sativa and Oryza glaberrima); and sugar cane;
Legumes (Fabaceae), including e.g. soybeans (Glycine max.), peanuts (Arachis hypogaea and pulse crops such as peas including Pisum sativum, pigeon pea and cowpea, beans including broad beans (Vicia faba), Vigna spp., and Phaseolus spp. and lentils (lens culinaris var.);
brassicaceae, including e.g. canola (Brassica napus), oilseed rape (OSR, Brassica napus), cabbage (B. oleracea var.), mustard such as B. juncea, B. campestris, B. narinosa, B. nigra and B. tournefortii; and turnip (Brassica rapa var.);
other broadleaf crops including e.g. sunflower, cotton, flax, linseed, sugarbeet, potato and tomato;
TNV-crops (TNV: trees, nuts and vine) including e.g. grapes, citrus, pomefruit, e.g. apple and pear, coffee, pistachio and oilpalm, stonefruit, e.g. peach, almond, walnut, olive, cherry, plum and apricot;
turf, pasture and rangeland;
onion and garlic;
bulb ornamentals such as tulips and narcissus;
conifers and deciduous trees such as Pinus, fir, oak, maple, dogwood, hawthorne, crabapple, and Rhamnus (buckthorn); and
garden ornamentals such as roses, Petunia, marigold and snapdragon.

In one embodiment, the method for controlling undesired vegetation is applied in cultivated rice, maize, pulse crops, cotton, canola, small grain cereals, soybeans, peanut, sugarcane, sunflower, plantation crops, tree crops, nuts or grapes. In another embodiment, the method is applied in cultivated crops selected from glufosinate-tolerant crops.

The spray liquors containing the copolymer CP are in particular suitable for burndown of undesired vegetation in fields of the following crop plants: small grain crops such as wheat, barley, rye, triticale and durum, rice, maize (corn), sugarcane, sorghum, soybean, pulse crops such as pea, bean and lentils, peanut, sunflower, sugarbeet, potato, cotton, brassica crops, such as oilseed rape, canola, mustard, cabbage and turnip, turf, pasture, rangeland, grapes, pomefruit, such as apple and pear, stonefruit, such as peach, almond, walnut, pecans, olive, cherry, plum and apricot, citrus, coffee, pistachio, garden ornamentals, such as roses, petunia, marigold, snap dragon, bulb ornamentals such as tulips and Narcissus, conifers and deciduous trees such as Pinus, fir, oak, maple, dogwood, hawthorne, crabapple and Rhamnus.

The herbicidal compositions are most suitable for burndown of undesired vegetation in fields of the following crop plants: small grain crops such as wheat, barley, rye, triticale and durum, rice, maize, sugarcane, soybean, pulse crops such as pea, bean and lentils, peanut, sunflower, cotton, Brassica crops, such as oilseed rape, canola, turf, pasture, rangeland, grapes, stonefruit, such as peach, almond, walnut, pecans, olive, cherry, plum and apricot, citrus and pistachio.

### I. Abbreviations

AMS ammonium sulfate
DAT days after treatment
fl oz fluid ounce
fl gal fluid gallon
GAP fluid gallons per acre
ha hectare
ae acid equivalent

### II. Production of the copolymers CP1 to CP5

The following monomers were used for producing the copolymers CP.
AMPS-Na: commercial grade of 2-acrylamide-2-methylpropane sulfonic acid sodium salt as a 50% by weight aqueous solution
AM Commercial grade acrylamide as a 50% by weight aqueous solution
DIMAPA-Q 3-Dimethylaminopropyl acrylamide, quaternised with methyl chloride
Monomer Mc-1: Monomer of the formula H₂C═CH—O—(CH₂)₄—O-(EO)_{24.5}-(BuO)₁₆-(EO)_{3.5}H, prepared according to example M/25 of WO 2014/095608
Monomer Mc-1: Monomer of the formula H₂C═CH—O—(CH₂)₄—O-(EO)_{24.5}-(BuO)₂₂-(EO)_{3.5}H, prepared according to example M/25 of WO 2014/095608

In monomers Mc-1 and Mc-2, EO refers to CH₂CH₂O, while BuO refers to CH₂CH(CH₂CH₃)O and CH(CH₂CH₃)CH₂O.

The polymers where prepared by analogy to the standard protocol of example C₁ on page 43 of WO 2014/095608 using the relative amount of the respective monomers given in the following table 1. Relative amounts are given as pphm (parts per 100 parts of monomers).

TABLE 1
Monomer composition of copolymers CP1 to CP5

| | CP1 | CP2 | CP3 | CP4 | CP5 |
|---|---|---|---|---|---|
| AMPS-Na [pphm] | 10 | 0 | 5 | 2 | 98.5 |
| AM [pphm] | 90 | 97 | 94.4 | 97 | 0 |
| DIMAPA-Q [pphm] | 0 | 2 | 0 | 0 | 0 |
| Monomer Mc-1 [pphm] | 0 | 1 | 0 | 1 | 1.5 |
| Monomer Mc-2 [pphm] | 0 | 0 | 0.6 | 0 | 0 |

All copolymers CP1 to CP5 had a weight average molecular weight in the range of 1,000,000 to 30,000,000 g/mol. The intrinsic viscosity of CP1 to CP5 is at least 200 cm³/g, estimated to the Mark-Houwink equation (1) and referring to the intrinsic visocisty of an aqueous solution of the copolymer CP in 0.5 M aqueous NaCl at 30° C.

For purpose of comparison, a commercial polyacrylamide homopolymer (polymer CP6) was used, namely Magnafloc 351.

### III. Field Trial Protocol, Polymeric Adjuvants with Glufosinate or Glyphosate Herbicide

(1) Field Trial 1 & 2 with Glufosinate

Glufosinate was used as the commercial aqueous SL formulation Liberty® 280 SL of BASF SE, containing 24.5% by weight of glufosinate ammonium.

The field was planted with glufosinate resistant soybeans (Glycine max) at a rate of 140,000 seeds/acre in 30 inch row spacing. The glufosinate resistance soybean seed for each trial is listed in the subsequent trial table. The weed pests were naturally occurring at the test site and are defined in subsequent tables listing trial results.

Each treatment plot was 30 feet in length and 6.67 feet in width giving a treatment area of 200 square feet. Plots were arranged in a grid pattern. Four replicate applications were made for each treatment using a randomized complete block (RCB) study design. Treatments were performed when weeds were 6 to 8 inches in height on average.

Spray solutions were prepared at with 1.4 fl oz/fl gal of Liberty 280 SL. The copolymer CP and optionally AMS were included at the concentrations defined in the subsequent tables 2 to 3.

Treatments were made using an ATV (All-Terrain Vehicle) with a 6.67 foot boom and XR 11006 nozzles at 20 inch spacing. The spray tank was operated at 40 psi pressure and the ground speed of the ATV during application was 11.9 mph for a spray volume of 15 gallons/acre (about 140 L/ha).

The application rate of Liberty® 280 SL was 22 fl oz/acre corresponding to 400 g/ha of glufosinate ammonium.

Observations of the soybeans (negative control) and the weed species were performed at 14 and 28 days after treatment (DAT) using a scale of 0% of no control to 100% for complete control which is a scale typical for use by an agronomist skilled in the art. Results were subjected to statistical analysis, analysis of variance as is standard practice when interpreting field trial data.

Field Trial 3 with Glyphosate:

Glyphosate was used as the commercial aqueous SL formulation Touchdown HiTech of Syngenta Crop Protection, LLC, containing 52.3% by weight of glyphosate-monopotassium.

The field was planted with glyphosate resistant soybeans (Glycine max) at a rate of 142,000 seeds/acre in 30 inch row spacing. The glyphosate resistant soybean seed for each trial is listed in the subsequent trail table. The weed pests were naturally occurring at the test site and are defined in subsequent tables listing trial results.

Each treatment plot was 25 feet in length and 6.67 feet in width giving a treatment area of 167 square feet. Plots were arranged in a grid pattern. Four replicate applications were made for each treatment using a randomized complete block (RCB) study design. Treatments were performed when weeds were 6 to 8 inches in height on average.

Spray solutions were prepared at 5 lbs ae (acid equivalent)/fl gal of Touchdown HiTech. The copolymer CP was included at the concentrations defined in the subsequent table 4.

Treatments were made using a backpack sprayer with a 6.67 foot boom and XR 8002 nozzles at 20 inch spacing. The spray tank was operated at 27 psi pressure for a spray volume of 15 gallons/acre.

The application rate of Touchdown HiTech was 8 fl oz/acre (0.313 lb ae/acre of glyphosate) corresponding to 350 g/ha of glyphosate.

Observations of the soybeans (negative control) and the weed species were performed at 14 and 28 days after treatment (DAT) using a scale of 0% of no control to 100% for complete control which is a scale typical for use by an agronomist skilled in the art. Results were subjected to statistical analysis, analysis of variance as is standard practice when interpreting field trial data.

Field trial 1: The trials were carried out in crops of glufosinate resistant soybean variety Becks 298L4. The results are summarized in the following table 2: Field trial 2: The trials were carried out in crops of glufosinate resistant soybean variety LL Credenz CZ2915L. The results are summarized in the following table 3.

Field trial 3: The trials were carried out in crops of glyphosate resistant soybean variety Stine 32EA12. The results are summarized in the following table 4.

TABLE 2
22 fl oz/acre of Liberty 280 SL with copolymer CP

| Copolymer | | % control 14 DAT | | % control 28 DAT | |
|---|---|---|---|---|---|
| Type | Concentration | Water hemp | Giant Foxtail | Water hemp | Giant Foxtail |
| — | 0 | 63.8 | 58.8 | 65.0 | 57.5 |
| CP6* | 125 ppm | 66.3 | 65.0 | 65.0 | 63.8 |
| CP1 | 100 ppm | 72.5 | 71.3 | 77.5 | 75.0 |
| CP1 | 50 ppm | 77.5 | 76.3 | 80.0 | 76.3 |

TABLE 3
22 fl oz/acre of Liberty 280 SL with 3 lb/acre of AMS and copolymer CP

| Copolymer | | % control 14 DAT | | % control 28 DAT | |
|---|---|---|---|---|---|
| | Concentration | Water hemp | Giant Foxtail | Water hemp | Giant Foxtail |
| | 0 | 88.3 | 75.0 | 70.0 | 58.8 |
| CP6* | 131 ppm | 73.3 | 77.5 | 48.0 | 65.0 |
| CP1 | 10 ppm | 88.8 | 80.0 | 71.0 | 68.8 |
| CP1 | 20 ppm | 93.3 | 84.3 | 76.0 | 70.8 |
| CP2 | 146 ppm | 88.0 | 75.0 | 67.0 | 61.3 |
| CP2 | 73 ppm | 84.8 | 79.5 | 63.8 | 70.0 |
| CP3 | 148 ppm | 84.0 | 75.4 | 62.5 | 62.0 |
| CP3 | 74 ppm | 82.3 | 77.5 | 60.0 | 66.0 |
| CP4 | 149 ppm | 85.8 | 79.5 | 61.3 | 68.8 |
| CP4 | 76 ppm | 86.0 | 80.0 | 65.0 | 67.0 |
| CP5 | 161 ppm | 81.5 | 75.8 | 59.5 | 61.8 |
| CP5 | 74 ppm | 84.0 | 79.0 | 59.3 | 67.5 |

TABLE 4
8 fl oz/acre of Touchdown HiTech with copolymer CP

| Copolymer | | % control 14 DAT | | | % control 28 DAT | | |
|---|---|---|---|---|---|---|---|
| Type | Concentration | BG | VL | LQ | BG | VL | LQ |
| — | 0 | 72.0 | 67.5 | 18.8 | 65.0 | 77.0 | 15.0 |
| CP1 | 50 ppm | 72.5 | 71.0 | 30.0 | 67.5 | 73.8 | 33.8 |
| CP1 | 100 ppm | 70.0 | 73.8 | 27.5 | 65.0 | 72.5 | 25.0 |

BG: Barnyard Grass;
VL: Velvet leaf;
LQ: Lambsquarters

### IV. Greenhouse Trial Protocol, Polymeric Adjuvants with Dicamba Herbicide

Dicamba was used as the commercial aqueous SL formulation ENGENIA® of BASE SE, containing 48% by weight of dicamba in the form of its N,N-bis(3-aminopropyl)methylamine salt.

A greenhouse study was conducted to evaluate the effect of the copolymers of the invention on the weed control efficacy of dicamba. Seedlings of common lambsquarters (Chenopodium album; OCHEAL), velvetleaf (Abutilon theophrasti, ABUTH), and waterhemp (Amaranthus tuberculatus, AMATA) were grown in 10x 10x 10 cm pots filled Metro-Mix 360 media (Sun Gro Horticulture, Agawam, MA). The weeds were treated with postemergence applications of dicamba at 560 g ae/ha (Engenia herbicide—BASE Agricultural Products, RTP, NO) alone and combined with various concentrations of the copolymers (20 to 100 ppm). All treatments included an adjuvant based on a non-ionic surfactant blend (Induce®—Helena Agri-Enterprises, Collierville, TN, proprietary blend of alkyl aryl Polyoxylkane ethers, alkanolamides, dimethyl siloxane and free fatty acids) at 0.25% v/v and were applied using a TeeJet AIXR 110015 nozzle (Spraying Systems, Wheaton, IL) at a spray volume of 140 I/ha when weeds were approximately 10 cm in height. All mixtures resulted in stable, clear spray solutions.

Some reduction in the width of the spray pattern was observed with the 80 and 100 ppm concentrations of copolymer CP1. Visual evaluation of weed control on a scale of 0 (no injury) to 100% (complete control) was made.

TABLE 5
Improvement in Dicamba Efficacy provided by copolymer CP1

| | % Control (21 Days after Treatment) | | | | % |
|---|---|---|---|---|---|
| TREATMENTS* | AMATA | ABUTH | CHEAL | Mean | Improvement |
| Dicamba (560 g ae/ha) | 83 | 53 | 86 | 74 | |
| Dicamba (560 g ae/ha) + CP1 (20 ppm) | 84 | 60 | 80 | 75 | 1 |
| Dicamba (560 g ae/ha) + CP1 (30 ppm) | 95 | 61 | 88 | 81 | 7 |
| Dicamba (560 g ae/ha) + CP1 (40 ppm) | 98 | 56 | 96 | 83 | 9 |
| Dicamba (560 g ae/ha) + CP1 (50 ppm) | 96 | 54 | 96 | 82 | 8 |
| Dicamba (560 g ae/ha) + CP1 (80 ppm) | 96 | 59 | 96 | 84 | 10 |
| Dicamba (560 g ae/ha) + CP1 (100 ppm) | 95 | 56 | 100 | 84 | 10 |

*All treatments applied with Induce ® at 0.25% v/v.

While weed control response varied across species, the addition of CP1 provided a consistent improvement in control with increasing concentration. ABUTH is generally less responsive to dicamba and the increase in control with CP1 plateaued at about 20 to 30 ppm while AMATA and CHEAL are more responsive to dicamba and the improvement with DRP continued through 40 to 80 ppm. Amaranthus species such as AMATA are increasingly troublesome weeds and an increase in control of more than 5% would be a significant benefit for farmers.

1. A method for increasing the efficacy of a herbicide which comprises applying an aqueous spray liquor of the herbicide in combination with a copolymer CP, where the copolymer CP is made of repeating units of polymerized ethylenically unsaturated monomers M comprising
a) 50 to 99.5% by weight, based on the total weight of ethylenically unsaturated monomers M, of at least one monomer Ma selected from the group consisting of primary amides of a monoethylenically unsaturated monocarboxylic acid having 3 to 6 carbon atoms;
b) 0 to 50% by weight, based on the total weight of ethylenically unsaturated monomers M, of one or more monomers Mb, where the monomer Mb is either
at least one monomer Mb.1 selected from the group consisting of monoethylenically unsaturated sulfonic acids and the salts thereof; or
at least one monomer Mb.2 selected from the group consisting of monoethylenically unsaturated monomers bearing at least one quaternary ammonium group; and
c) 0 to 15% by weight, based on the total weight of ethylenically unsaturated monomers M, of one or more monoethylenically unsaturated monomers Mc having at least one poly-C₂-C₆-alkyleneoxide moiety which has a terminal OH group or a terminal C₁-C₆-alkxoy group in addition to the moiety bearing an ethylenically unsaturated double bond;
where the total amount of monomers Ma and Mb is at least 85% by weight, based on the total weight of ethylenically unsaturated monomers M, and where the total amount monomers Mb and Mc is from 0.5 to 50% by weight, based on the total weight of ethylenically unsaturated monomers M.

2. The method of claim 1, wherein the monomer Ma is acrylamide.

3. The method of any one of the preceding claims, wherein the monomers M comprise from 0.5 to 50% by weight, of at least one monomer Mb.1.

4. The method of any one of the preceding claims, wherein the monomer Mb.1 is 2-acrylamido-2-methylpropane sulfonic acid or a salt thereof.

5. The method of any one of the preceding claims, wherein the monomers M forming the copolymer consist of the monomer Ma and the monomer Mb.1, and where the monomers M in particular consist of
a) 70 to 99% by weight, based on the total weight of the ethylenically unsaturated monomers M, of acrylamide;
and
b) 1 to 30% by weight, based on the total weight of the ethylenically unsaturated monomers M, of 2-acrylamido-2-methylpropane sulfonic acid or a salt thereof.

6. The method of any one of claims 1 to 2, wherein the monomers M comprise from 0.5 to 5% by weight, of at least one monomer Mb.2.

7. The method of any one of claims 1 to 2 and 6, wherein the monomer Mb.2 is a N-(3-trimethylammoniumpropyl) acrylamide salt, in particular the chloride, the sulfate or the methosulfate thereof.

8. The method of any one of claims 1 to 3 or 6 or 7, wherein the monomers M forming the copolymer comprise from 0.5 to 5% by weight, based on the total weight of the monomers M, of at least one monomer Mc.

9. The method of any one of the preceding claims, wherein the copolymer CP in the form of its sodium salt has a weight average molecular weight Mw of at least 100,000 g/mol, in particular at least 250,000 g/mol, more particular at least 500,000 g/mol, as determined by gel permeation chromatography.

10. The method of any one of the preceding claims, wherein the copolymer CP in the form of its sodium salt has an intrinsic viscosity [η] of at least 50 cm³/g, in particular at least 100 cm³/g, preferably at least 150 cm³/g, especially at least 200 cm³/g as determined at 30° C. for a solution of the copolymer CP in a 0.5 M aqueous solution of sodium chloride.

11. The use of a copolymer CP as defined in any one of the preceding claims for increasing the efficacy of a herbicide.

12. The method or use of any one of the preceding claims, wherein the copolymers CP are applied in an amount of 5 to 500 ppm, in particular in an amount of 10 to 300 ppm, more preferably in an amount of 10 to 200 ppm, especially in an amount of 10 to 100 ppm, based on the total weight of the aqueous spray liquor.

13. The method or use of any one of the preceding claims, wherein the spray liquor has at least one of the properties (1), (2) or (3):
(1) the spray liquor has a pH in the range of pH 4 to pH 9, as determined at 25° C.;
(2) the spray liquor additionally contains an inorganic salt or a salt of an organic acid;
(3) the spray liquor additionally contains an ammonium salt, in particular ammonium sulfate.

14. The method or use of any one of the preceding claims, where the herbicide is an organic herbicide compound selected from the group consisting of
(i) herbicides of the group of glutamine synthetase inhibitors;
(ii) herbicides of the group of 5-enolpyruvylshikimate-3-phosphate synthase inhibitors (EPSP synthase inhibitors);
(iii) herbicides of the group of auxin agonists;
(iv) herbicides of the group of protoporphyrinogen oxidase inhibitors (PPO inhibitors);
(v) herbicides of the group of acetolactate synthase inhibitors (ALS inhibitors);
(vi) herbicides of the group of photosystem II inhibitors (PS II inhibitors);
(vii) herbicides of the group of hydroxyphenylpyruvate dioxygenase inhibitors (HPPD inhibitors);
(viii) herbicides of the group of acetyl-CoA carboxylase inhibitors (ACCase inhibitors), and combinations thereof.

15. The method or use of claim 14, where the organic herbicide compound comprises at least one herbicide compound, selected from the group of glufosinate, bialaphos, glyphosate, dicamba, chloramben, 2,4-D, endothal, mecoprop, picloram, triclopyr, fluroxypyr, 2,4,5-T, benzac, MCPA, MCPB, dichlorprop, dichlorprop P, imazamox, imazapyr, imazapic, imazethapyr, imazaquin, cloransulam, chlorimuron, acifluorfen, saflufenacil, fomesafen, acifluorfen, atrazine, propanil, bentazon, diuron, quizalofop, clethodim, pinoxaden, topramezone, mesotrione, the salts thereof, the esters thereof and combinations thereof.

16. The method or use of claim 15, where the organic herbicide compound comprises at least one herbicide compound selected from the group consisting of glufosinate, dicamba, glyphosate and the salts thereof.

17. An aqueous spray liquor containing a herbicide compound and a copolymer CP, is made of repeating units of polymerized ethylenically unsaturated monomers M consisting of:
a) 50 to 99.5% by weight, based on the total weight of ethylenically unsaturated monomers M, of at least one monomer Ma selected from the group consisting of primary amides of a monoethylenically unsaturated monocarboxylic acid having 3 to 6 carbon atoms; and
b) 0.5 to 50% by weight, based on the total weight of ethylenically unsaturated monomers M, of one or more monomers Mb, where the monomer Mb is either
at least one monomer Mb.1 selected from the group consisting of monoethylenically unsaturated sulfonic acids and the salts thereof; or
at least one monomer Mb.2 selected from the group consisting of monoethylenically unsaturated monomers bearing at least one quaternary ammonium group.

18. The aqueous spray liquor of claim 17, wherein the copolymer CP has at least one of the following properties i), ii), iii), iv), v), iv) or vii):
i) the monomer Ma is acrylamide;
ii) the monomers M comprise from 0.5 to 50% by weight, of at least one monomer Mb.1;
ii) the monomer Mb.1 is 2-acrylamido-2-methylpropane sulfonic acid or a salt thereof;
iv) the monomers M consist of
a) 70 to 99% by weight, based on the total weight of the ethylenically unsaturated monomers M, of acrylamide;
and
b) 1 to 30% by weight, based on the total weight of the ethylenically unsaturated monomers M, of a monomer Mb.1, which is in particular 2-acrylamido-2-methylpropane sulfonic acid or a salt thereof;
v) the copolymer CP in the form of its sodium salt has a weight average molecular weight Mw of at least 100,000 g/mol, in particular at least 250,000 g/mol, more particular at least 500,000 g/mol, as determined by gel permeation chromatography;
vi) the copolymer CP in the form of its sodium salt has an intrinsic viscosity [η] of at least 50 cm³/g, in particular at least 100 cm³/g, preferably at least 150 cm³/g, especially at least 200 cm³/g as determined at 30° C. for a solution of the copolymer CP in a 0.5 M aqueous solution of sodium chloride;
vii) the monomers M consist of
a) 95 to 99.5% by weight, based on the total weight of the ethylenically unsaturated monomers M, of acrylamide;
and
b) 0.5 to 5% by weight, based on the total weight of the ethylenically unsaturated monomers M, of a monomer Mb.2, which is in particular a N-(3-trimethylammoniumpropyl) acrylamide salt.

19. The aqueous spray liquor of any one of claim 17 or 18, wherein the spray liquor has at least one of the properties (1), (2) or (3):
(1) the spray liquor has a pH in the range of pH 4 to pH 9, as determined at 25° C.;
(2) the spray liquor additionally contains an inorganic salt or a salt of an organic acid;
(3) the spray liquor additionally contains an ammonium salt, in particular ammonium sulfate.
